(19) United States
(12) Patent Application Publication
(10) Pub. No.: US 2025/0034316 A1
(43) Pub. Date: Jan. 30, 2025

(54) CURABLE COMPOSITION, CURED PRODUCT AND CURING CATALYST FOR BLOCKED ISOCYANATE COMPOUND

(71) Applicant: KOEI CHEMICAL COMPANY, LIMITED, Chiba (JP)

(72) Inventors: Mitsuki ONODA, Chiba (JP); Motoyoshi MIYAGI, Chiba (JP); Syougo NAGAYAMA, Chiba (JP)

(73) Assignee: KOEI CHEMICAL COMPANY, LIMITED, Chiba (JP)

(21) Appl. No.: 18/714,360

(22) PCT Filed: Nov. 29, 2022
(86) PCT No.: PCT/JP2022/043873

§ 371 Date: May 29, 2024

(30) Foreign Application Priority Data
Nov. 30, 2021 (JP) 2021-194813

(51) Int. Cl. C08G 18/22; C07F 7/00; C07F 7/28; C07F 9/09; C07F 11/00; C07F 15/02; C07F 15/04; C07F 15/06; C08G 18/42; C08G 18/62; C08G 18/80

(52) U.S. Cl. CPC C08G 18/222; C07F 7/003; C07F 7/28; C07F 9/095; C07F 11/005; C07F 15/025; C07F 15/045; C07F 15/065; C08G 18/42; C08G 18/6229; C08G 18/807; C08G 18/8077

(57) ABSTRACT

The present invention provides a curable composition comprising one or more metal complex compounds comprising at least one metal from Groups 4 to 13, and a blocked isocyanate compound in which an isocyanate group of an isocyanate compound is blocked with a nitrogen-containing compound represented by the following Formula (1) or Formula (2).

Formula (1):

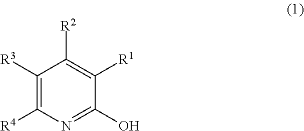

wherein R¹, R², R³, and R⁴ are as defined in the specification; or

Formula (2):

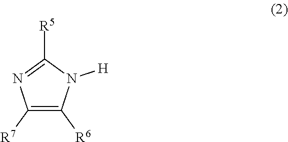

wherein R⁵, R⁶, and R⁷ are as defined in the specification.

### TECHNICAL FIELD

The present invention relates to a curable composition, a cured product, and a curing catalyst for a blocked isocyanate compound.

### BACKGROUND ART

In order for compositions of reacting isocyanate compounds with water and compounds having an isocyanate-reactive group, such as polyols, to have storage stability, it is common to use blocked isocyanates in which isocyanate moieties of isocyanate compounds are protected by a blocking agent. Heating a composition containing such a blocked isocyanate dissociates the blocking agent from the blocked isocyanate, causing the composition to cure.

A known blocked isocyanate is, for example, 2-hydroxypyridine-blocked isocyanate (NPL 1 and PTL 1).

### CITATION LIST

### Patent Literature

PTL 1: JP2014-091768A
PTL 2: WO2017/104649

### Non-Patent Literature

NPL 1: Materials 2016, 9, 110

### SUMMARY OF INVENTION

### Technical Problem

The present inventors attempted to produce polyurea by moisture-curing 2-hydroxypyridine-blocked isocyanate in the presence of bis(2-dimethylaminoethyl)ether, which is the curing catalyst described in PTL 2. However, curing properties at low temperatures (100° C. or less) were not satisfactory (see the Comparative Examples provided later).

Further, with reference to the description of PTL 1, the present inventors attempted to cure a curable composition containing 2-hydroxypyridine-blocked isocyanate and a polyol, which is a compound having an isocyanate-reactive group. However, if the ratio of blocked isocyanate groups in the 2-hydroxypyridine-blocked isocyanate compound to hydroxy groups in the polyol was more than 1 equivalent, when dibutyltin dilaurate was used as a curing catalyst, a satisfactory rate of curing at low temperatures could not be achieved (see the Comparative Examples provided later).

The present invention was made in view of the above background art. An object of the present invention is to provide a curable composition comprising a blocked isocyanate compound that can be cured at low temperatures.

Another object of the present invention is to provide a curable composition comprising a blocked isocyanate compound and a compound having an isocyanate-reactive group that has sufficient curing properties at low temperatures even when the ratio of blocked isocyanate groups in the blocked isocyanate compound to isocyanate-reactive groups in the compound having an isocyanate-reactive group is more than 1 equivalent.

Still another object of the present invention is to provide a curing catalyst for a blocked isocyanate compound that ensures excellent low-temperature curing properties of blocked isocyanates blocked with a nitrogen-containing compound.

### Solution to Problem

The present inventors conducted extensive research to solve the above problem, and found that when one or more metal complex compounds comprising at least one metal from Groups 4 to 13 were used as a curing catalyst for a blocked isocyanate compound blocked with a nitrogen-containing compound represented by Formula (1) or Formula (2), excellent low-temperature curing properties were achieved. The present invention has thus been accomplished.

The present invention provides the following curable composition, cured product, and curing catalyst for a blocked isocyanate compound.

[1]

A curable composition comprising one or more metal complex compounds comprising at least one metal from Groups 4 to 13, and a blocked isocyanate compound in which an isocyanate group of an isocyanate compound is blocked with a nitrogen-containing compound represented by the following Formula (1) or Formula (2).

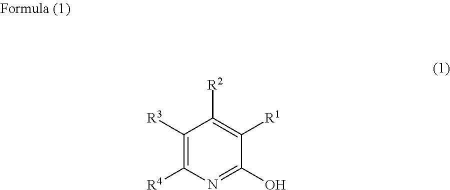

wherein R¹, R², R³, and R⁴ are the same or different, and each represents a C₁₋₂₀ hydrocarbon group optionally containing at least one member selected from the group consisting of a heteroatom and a halogen atom, a hydrogen atom, a halogen atom, or a —X¹R^{a}(R^{b})ₐ₁ group, wherein X¹ is an oxygen atom or a nitrogen atom, a1 is 0 or 1, when X¹ is an oxygen atom, a1 is 0, and when X¹ is a nitrogen atom, a1 is 1; R^{a} and R^{b} are the same or different, and each represents a C₁₋₂₀ hydrocarbon group optionally containing a heteroatom or a halogen atom; R¹ and R² and/or R² and R³ and/or R³ and R⁴ may form a ring structure together with the carbon atoms to which they are bonded; and the heteroatom is at least one member selected from the group consisting of a nitrogen atom, an oxygen atom, and a sulfur atom; or

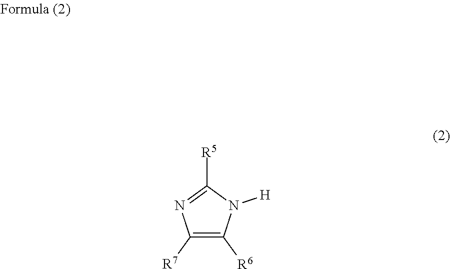

wherein R⁵, R⁶, and R⁷ are the same or different, and each represents a C₁₋₂₀ hydrocarbon group optionally containing at least one member selected from the group consisting of a heteroatom and a halogen atom, a hydrogen atom, a halogen atom, or a —X²R^{c}(R^{d})ₐ₂ group, wherein X² is an oxygen atom or a nitrogen atom, a2 is 0 or 1, when X² is an oxygen atom, a2 is 0, and when X² is a nitrogen atom, a2 is 1; R^{c} and R^{d} are the same or different, and each represents a C₁₋₂₀ hydrocarbon group optionally containing at least one member selected from the group consisting of a heteroatom and a halogen atom; R⁶ and R⁷ may form a ring structure together with the carbon atoms to which they are bonded; and the heteroatom is at least one member selected from the group consisting of a nitrogen atom, an oxygen atom, and a sulfur atom.
[2]

The curable composition according to [1], wherein the metal from Groups 4 to 13 is a metal of Group 4 or 6.

[3]

The curable composition according to [1] or [2], wherein the metal from Groups 4 to 13 is titanium of Group 4 or molybdenum of Group 6.

[4]

The curable composition according to any one of [1] to [3], wherein the metal complex compound is a metal complex compound having at least one ligand selected from the group consisting of a β-diketonate ligand, an alkoxide ligand, a carboxylate ligand, a sulfonate ligand, and a phosphate ligand.

[5]

The curable composition according to any one of [1] to [4], wherein the metal complex compound is a metal complex compound having at least one ligand selected from the group consisting of a β-diketonate ligand represented by the following Formula (3), an alkoxide ligand represented by the following Formula (4), a carboxylate ligand represented by the following Formula (5), a sulfonate ligand represented by the following Formula (6), and a phosphate ligand represented by the following Formula (7).

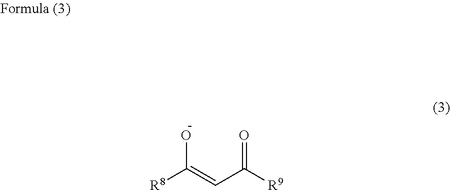

wherein R⁸ and R⁹ are the same or different, and each represents a C₁₋₂₀ hydrocarbon group optionally having at least one member selected from the group consisting of a heteroatom and a halogen atom, or a —X³R^{e}(R^{f})ₐ₃ group, wherein X³ is an oxygen atom or a nitrogen atom, a3 is 0 or 1, when X³ is an oxygen atom, a3 is 0, and when X³ is a nitrogen atom, a3 is 1; R^{e} and R^{f} are the same or different, and each represents a C₁₋₂₀ hydrocarbon group optionally containing at least one member selected from the group consisting of a heteroatom and a halogen atom; and the heteroatom is at least one member selected from the group consisting of a nitrogen atom, an oxygen atom, and a sulfur atom;

Formula (4):

R¹⁰O⁻ (4)

wherein R¹⁰ is a C₁₋₂₀ hydrocarbon group optionally having at least one member selected from the group consisting of a heteroatom, a halogen atom, a hydroxy group, and an oxyanion group (—O⁻ group); and the heteroatom is at least one member selected from the group consisting of a nitrogen atom, an oxygen atom, and a sulfur atom, and is bonded to two carbon atoms;

Formula (5):

R¹¹COO⁻ (5)

wherein R¹¹ is a C₁₋₂₀ hydrocarbon group optionally having at least one member selected from the group consisting of a heteroatom and a halogen atom; and the heteroatom is at least one member selected from the group consisting of a nitrogen atom, an oxygen atom, and a sulfur atom;

Formula (6):

R¹²SO₃⁻ (6)

wherein R¹² is a C₁₋₂₀ hydrocarbon group optionally having at least one member selected from the group consisting of a heteroatom and a halogen atom; and the heteroatom is at least one member selected from the group consisting of a nitrogen atom, an oxygen atom, and a sulfur atom; and

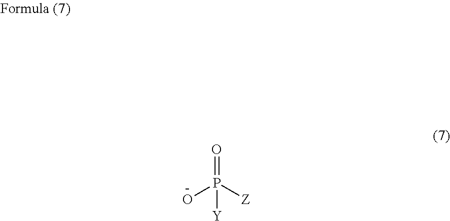

wherein Y is an oxyanion group (—O⁻ group) or OR¹³, Z is an oxyanion group (—O⁻ group) or OR¹⁴; R¹³ and R¹⁴ are the same or different, and each represents a C₁₋₂₀ hydrocarbon group optionally having at least one member selected from the group consisting of a heteroatom and a halogen atom, or a hydrogen atom; and the heteroatom is at least one member selected from the group consisting of a nitrogen atom, an oxygen atom, and a sulfur atom, and is bonded to two carbon atoms.
[6]

The curable composition according to any one of [1] to [5], further comprising a compound having an isocyanate-reactive group.

[7]

The curable composition according to [6], wherein the compound having an isocyanate-reactive group is a polyol.

[8]

The curable composition according to [6] or [7], wherein the ratio of blocked isocyanate groups in the blocked isocyanate compound and isocyanate-reactive groups in the compound having an isocyanate-reactive group is 100:1 to 100:70.

[9]

The curable composition according to any one of [1] to [8], wherein the isocyanate compound is at least one polyisocyanate selected from the group consisting of aliphatic polyisocyanates, alicyclic polyisocyanates, aromatic polyisocyanates, and aromatic aliphatic polyisocyanates, or a modified isocyanate formed from at least one member selected from the group consisting of aliphatic polyisocyanates, alicyclic polyisocyanates, aromatic polyisocyanates, and aromatic aliphatic polyisocyanates.

[10]

A cured product obtained by heating the curable composition according to any one of [1] to [9] under air or in the presence of water.

[11]

A curing catalyst for a blocked isocyanate compound, comprising one or more metal complex compounds comprising at least one metal from Groups 4 to 13, wherein the blocked isocyanate compound is a compound in which an isocyanate group of an isocyanate compound is blocked with a nitrogen-containing compound represented by Formula (1) or Formula (2).

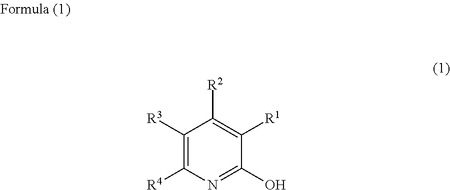

wherein R¹, R², R³, and R⁴ are the same or different, and each represents a C₁₋₂₀ hydrocarbon group optionally containing at least one member selected from the group consisting of a heteroatom and a halogen atom, a hydrogen atom, a halogen atom, or a —X¹R^{a}(R^{b})ₐ₁ group, wherein X¹ is an oxygen atom or a nitrogen atom, a1 is 0 or 1, when X¹ is an oxygen atom, a1 is 0, and when X¹ is a nitrogen atom, a1 is 1; R^{a} and R^{b} are the same or different, and each represents a C₁₋₂₀ hydrocarbon group optionally containing at least one member selected from the group consisting of a heteroatom and a halogen atom; R¹ and R² and/or R² and R³ and/or R³ and R⁴ may form a ring structure together with the carbon atoms to which they are bonded; and the heteroatom is at least one member selected from the group consisting of a nitrogen atom, an oxygen atom, and a sulfur atom; or

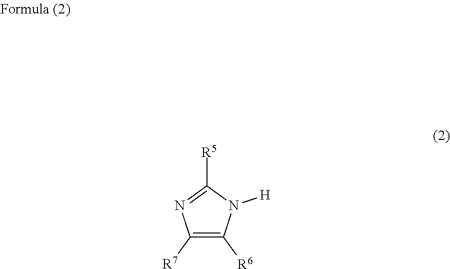

wherein R⁵, R⁶, and R⁷ are the same or different, and each represents a C₁₋₂₀ hydrocarbon group optionally containing at least one member selected from the group consisting of a heteroatom and a halogen atom, a hydrogen atom, a halogen atom, or a —X²R^{c}(R^{d})ₐ₂ group, wherein X² is an oxygen atom or a nitrogen atom, a2 is 0 or 1, when X² is an oxygen atom, a2 is 0, and when X² is a nitrogen atom, a2 is 1; R^{c} and R^{d} are the same or different, and each represents a C₁₋₂₀ hydrocarbon group optionally containing at least one member selected from the group consisting of a heteroatom and a halogen atom; R⁶ and R⁷ may form a ring structure together with the carbon atoms to which they are bonded; and the heteroatom is at least one member selected from the group consisting of a nitrogen atom, an oxygen atom, and a sulfur atom.
[12]

The curing catalyst for a blocked isocyanate compound according to [11], wherein the metal from Groups 4 to 13 is a metal of Group 4 or 6.

[13]

The curing catalyst for a blocked isocyanate compound according to [11] or [12], wherein the metal from Groups 4 to 13 is titanium of Group 4 or molybdenum of Group 6.

[14]

The curing catalyst for a blocked isocyanate compound according to any one of [11] to [13], wherein the metal complex compound is a metal complex compound having at least one ligand selected from the group consisting of a β-diketonate ligand, an alkoxide ligand, a carboxylate ligand, a sulfonate ligand, and a phosphate ligand.

[15]

The curing catalyst for a blocked isocyanate compound according to any one of [11] to [14], wherein the metal complex compound is a metal complex compound having at least one ligand selected from the group consisting of a β-diketonate ligand represented by the following Formula (3), an alkoxide ligand represented by the following Formula (4), a carboxylate ligand represented by the following Formula (5), a sulfonate ligand represented by the following Formula (6), and a phosphate ligand represented by the following Formula (7).

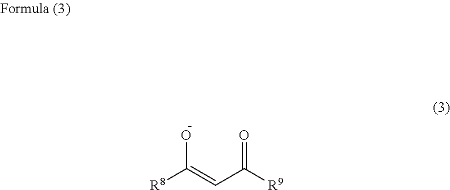

wherein R⁸ and R⁹ are the same or different, and each represents a C₁₋₂₀ hydrocarbon group optionally having at least one member selected from the group consisting of a heteroatom and a halogen atom, or a —X³R^{e}(R^{f})ₐ₃ group, wherein X³ is an oxygen atom or a nitrogen atom, a3 is 0 or 1, when X³ is an oxygen atom, a3 is 0, and when X³ is a nitrogen atom, a3 is 1; R^{e} and R^{f} are the same or different, and each represents a C₁₋₂₀ hydrocarbon group optionally containing at least one member selected from the group consisting of a heteroatom and a halogen atom; and the heteroatom is at least one member selected from the group consisting of a nitrogen atom, an oxygen atom, and a sulfur atom;

Formula (4):

R¹⁰O⁻ (4)

wherein R¹⁰ is a C₁₋₂₀ hydrocarbon group optionally having at least one member selected from the group consisting of a heteroatom, a halogen atom, a hydroxy group, and an oxyanion group (—O⁻ group); and the heteroatom is at least one member selected from the group consisting of a nitrogen atom, an oxygen atom, and a sulfur atom, and is bonded to two carbon atoms;

Formula (5):

R¹¹COO⁻ (5)

wherein R¹¹ is a C₁₋₂₀ hydrocarbon group optionally having at least one member selected from the group consisting of a heteroatom and a halogen atom; and the heteroatom is at least one member selected from the group consisting of a nitrogen atom, an oxygen atom, and a sulfur atom;

Formula (6):

R¹²SO₃⁻ (6)

wherein R¹² is a C₁₋₂₀ hydrocarbon group optionally having at least one member selected from the group consisting of a heteroatom and a halogen atom; and the heteroatom is at least one member selected from the group consisting of a nitrogen atom, an oxygen atom, and a sulfur atom; and

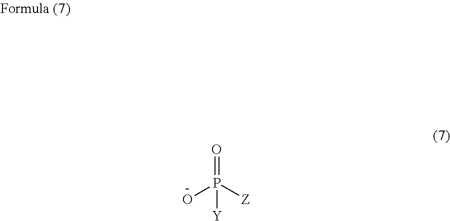

wherein Y is an oxyanion group (—O⁻ group) or OR¹³, Z is an oxyanion group (—O⁻ group) or OR¹⁴; R¹³ and R¹⁴ are the same or different, and each represents a C₁₋₂₀ hydrocarbon group or a hydrogen atom; and the heteroatom is at least one member selected from the group consisting of a nitrogen atom, an oxygen atom, and a sulfur atom, and is bonded to two carbon atoms.
[16]

The curing catalyst for a blocked isocyanate compound according to [11], wherein the metal complex compound is MoO₂(acac)₂, MoO₂(DPh)₂, MoO₂(NEt₂)₂, MoO₂(DtBu)₂, TiO(acac)₂, Ti(acac)₂(OiPr)₂, Ti(OiPr)₄, Ti(acac)₄, (Ti(OiPr)₂(OAc)₂)₂O, Ti(OiPr)₂(MeS₃)₂, Ti(OiPr)₂(P(OBu)₂O₂)₂, Zr(acac)₄, Hf(acac)₄, Fe(acac)₃, Co(acac)₂, Ni(acac)₂, titanium octyleneglycolate, titanium ethylacetoacetate, a titanium dodecylbenzene sulfonate compound, or titanium ethanolaminate.

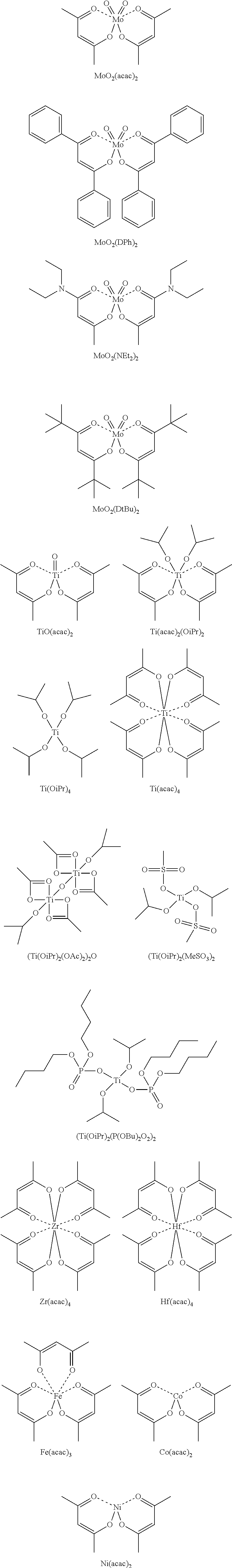

[17]

Use of one or more metal complex compounds comprising at least one metal from Groups 4 to 13 for producing a curing catalyst for a blocked isocyanate compound, wherein the blocked isocyanate compound is a compound in which an isocyanate group of an isocyanate compound is blocked with a nitrogen-containing compound represented by Formula (1) or Formula (2).

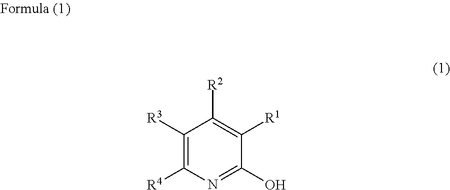

wherein R¹, R², R³, and R⁴ are the same or different, and each represents a C₁₋₂₀ hydrocarbon group optionally containing at least one member selected from the group consisting of a heteroatom and a halogen atom, a hydrogen atom, a halogen atom, or a —X¹R^{a}(R^{b})ₐ₁ group, wherein X¹ is an oxygen atom or a nitrogen atom, a1 is 0 or 1, when X¹ is an oxygen atom, a1 is 0, and when X¹ is a nitrogen atom, a1 is 1; R^{a} and R^{b} are the same or different, and each represents a C₁₋₂₀ hydrocarbon group optionally containing at least one member selected from the group consisting of a heteroatom and a halogen atom; R¹ and R² and/or R² and R³ and/or R³ and R⁴ may form a ring structure together with the carbon atoms to which they are bonded; and the heteroatom is at least one member selected from the group consisting of a nitrogen atom, an oxygen atom, and a sulfur atom; or

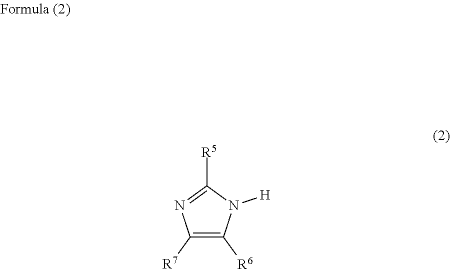

wherein R⁵, R⁶, and R⁷ are the same or different, and each represents a C₁₋₂₀ hydrocarbon group optionally containing at least one member selected from the group consisting of a heteroatom and a halogen atom, a hydrogen atom, a halogen atom, or a —X²R^{c}(R^{d})ₐ₂ group, wherein X² is an oxygen atom or a nitrogen atom, a2 is 0 or 1, when X² is an oxygen atom, a2 is 0, and when X² is a nitrogen atom, a2 is 1; R^{c} and R^{d} are the same or different, and each represents a C₁₋₂₀ hydrocarbon group optionally containing at least one member selected from the group consisting of a heteroatom and a halogen atom; R⁶ and R⁷ may form a ring structure together with the carbon atoms to which they are bonded; and the heteroatom is at least one member selected from the group consisting of a nitrogen atom, an oxygen atom, and a sulfur atom.
[18]

The use according to [17], wherein the metal from Groups 4 to 13 is a metal of Group 4 or 6.

[19]

The use according to [17] or [18], wherein the metal from Groups 4 to 13 is titanium of Group 4 or molybdenum of Group 6.

[20]

The use according to any one of [17] to [19], wherein the metal complex compound is a metal complex compound having at least one ligand selected from the group consisting of a β-diketonate ligand, an alkoxide ligand, a carboxylate ligand, a sulfonate ligand, and a phosphate ligand.

[21]

The use according to any one of [17] to [20], wherein the metal complex compound is a metal complex compound having at least one ligand selected from the group consisting of a β-diketonate ligand represented by the following Formula (3), an alkoxide ligand represented by the following Formula (4), a carboxylate ligand represented by the following Formula (5), a sulfonate ligand represented by the following Formula (6), and a phosphate ligand represented by the following Formula (7).

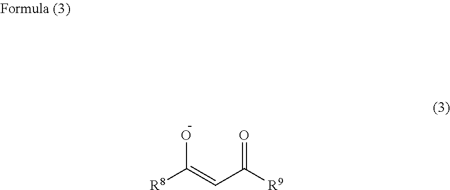

wherein R⁸ and R⁹ are the same or different, and each represents a C₁₋₂₀ hydrocarbon group optionally having at least one member selected from the group consisting of a heteroatom and a halogen atom, or a —X³R^{e}(R^{f})ₐ₃ group, wherein X³ is an oxygen atom or a nitrogen atom, a3 is 0 or 1, when X³ is an oxygen atom, a3 is 0, and when X³ is a nitrogen atom, a3 is 1; R^{e} and R^{f} are the same or different, and each represents a C₁₋₂₀ hydrocarbon group optionally containing at least one member selected from the group consisting of a heteroatom and a halogen atom; and the heteroatom is at least one member selected from the group consisting of a nitrogen atom, an oxygen atom, and a sulfur atom;

Formula (4):

R¹⁰O⁻ (4)

wherein R¹⁰ is a C₁₋₂₀ hydrocarbon group optionally having at least one member selected from the group consisting of a heteroatom, a halogen atom, a hydroxy group, and an oxyanion group (—O⁻ group); and the heteroatom is at least one member selected from the group consisting of a nitrogen atom, an oxygen atom, and a sulfur atom, and is bonded to two carbon atoms;

Formula (5):

R¹¹COO⁻ (5)

wherein R¹¹ is a C₁₋₂₀ hydrocarbon group optionally having at least one member selected from the group consisting of a heteroatom and a halogen atom; and the heteroatom is at least one member selected from the group consisting of a nitrogen atom, an oxygen atom, and a sulfur atom;

Formula (6):

R¹²SO₃⁻ (6)

wherein R¹² is a C₁₋₂₀ hydrocarbon group optionally having at least one member selected from the group consisting of a heteroatom and a halogen atom; and the heteroatom is at least one member selected from the group consisting of a nitrogen atom, an oxygen atom, and a sulfur atom; and

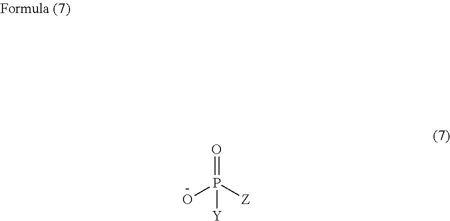

wherein Y is an oxyanion group (—O⁻ group) or OR¹³, Z is an oxyanion group (—O⁻ group) or OR¹⁴; R¹³ and R¹⁴ are the same or different, and each represents a C₁₋₂₀ hydrocarbon group or a hydrogen atom; and the heteroatom is at least one member selected from the group consisting of a nitrogen atom, an oxygen atom, and a sulfur atom, and is bonded to two carbon atoms.
[22]

The use according to any one of [17] to [21], wherein the metal complex compound is MoO₂(acac)₂, MoO₂(DPh)₂, MoO₂(NEt₂)₂, MoO₂(DtBu)₂, TiO(acac)₂, Ti(acac)₂(OiPr)₂, Ti(OiPr)₄, Ti(acac)₄, (Ti(OiPr)₂(OAc)₂)₂O, Ti(OiPr)₂(MeSO₃)₂, Ti(OiPr)₂(P(OBu)₂O₂)₂, Zr(acac)₄, Hf(acac)₄, Fe(acac)₃, Co(acac)₂, Ni(acac)₂, titanium octyleneglycolate, titanium ethylacetoacetate, a titanium dodecylbenzene sulfonate compound, or titanium ethanolaminate.

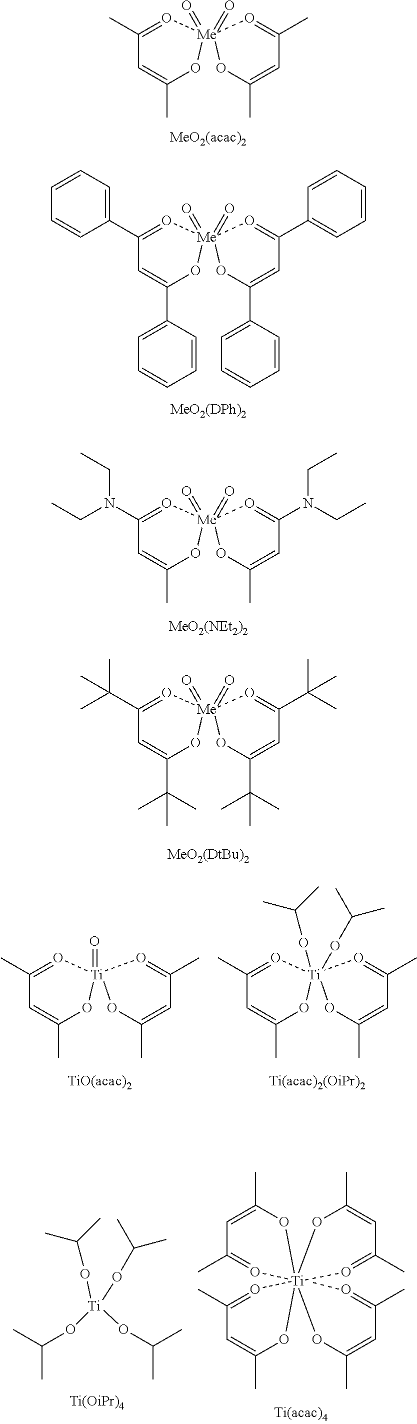

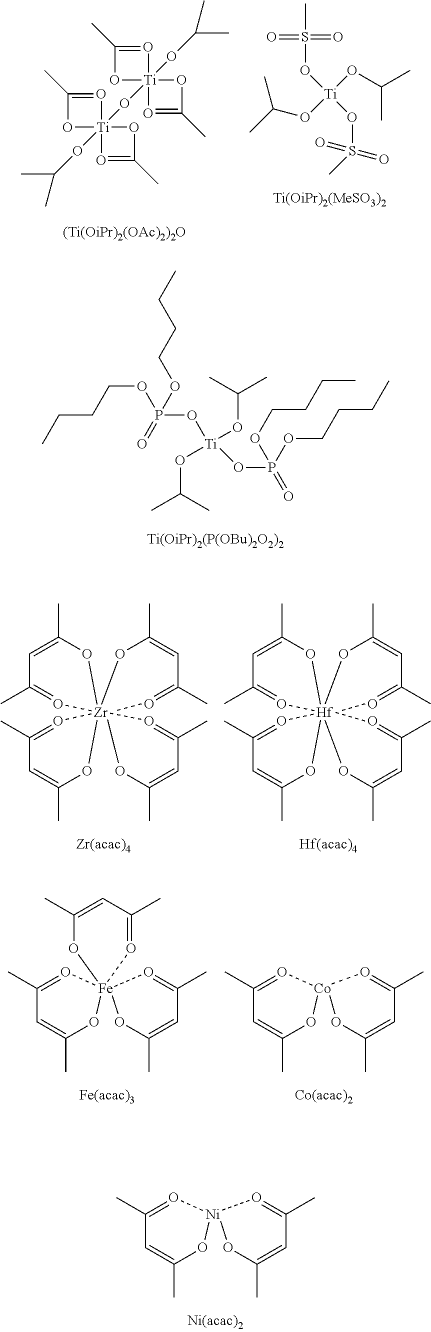

[23]

A method for curing a blocked isocyanate compound, comprising heating the blocked isocyanate compound in the presence of a curing catalyst for a blocked isocyanate compound comprising one or more metal complex compounds comprising at least one metal from Groups 4 to 13, wherein the blocked isocyanate compound is a compound in which an isocyanate group of an isocyanate compound is blocked with a nitrogen-containing compound represented by Formula (1) or Formula (2).

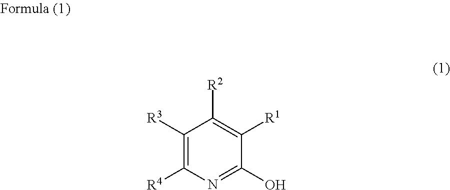

wherein R¹, R², R³, and R⁴ are the same or different, and each represents a C₁₋₂₀ hydrocarbon group optionally containing at least one member selected from the group consisting of a heteroatom and a halogen atom, a hydrogen atom, a halogen atom, or a —X¹R^{a}(R^{b})ₐ₁ group, wherein X¹ is an oxygen atom or a nitrogen atom, a1 is 0 or 1, when X¹ is an oxygen atom, a1 is 0, and when X¹ is a nitrogen atom, a1 is 1; R^{a} and R^{b} are the same or different, and each represents a C₁₋₂₀ hydrocarbon group optionally containing at least one member selected from the group consisting of a heteroatom and a halogen atom; R¹ and R² and/or R² and R³ and/or R³ and R⁴ may form a ring structure together with the carbon atoms to which they are bonded; and the heteroatom is at least one member selected from the group consisting of a nitrogen atom, an oxygen atom, and a sulfur atom; or

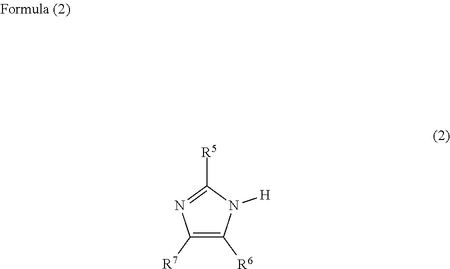

wherein R⁵, R⁶, and R⁷ are the same or different, and each represents a C₁₋₂₀ hydrocarbon group optionally containing at least one member selected from the group consisting of a heteroatom and a halogen atom, a hydrogen atom, a halogen atom, or a —X²R^{c}(R^{d})ₐ₂ group, wherein X² is an oxygen atom or a nitrogen atom, a2 is 0 or 1, when X² is an oxygen atom, a2 is 0, and when X² is a nitrogen atom, a2 is 1; R^{c} and R^{d} are the same or different, and each represents a C₁₋₂₀ hydrocarbon group optionally containing at least one member selected from the group consisting of a heteroatom and a halogen atom; R⁶ and R⁷ may form a ring structure together with the carbon atoms to which they are bonded; and the heteroatom is at least one member selected from the group consisting of a nitrogen atom, an oxygen atom, and a sulfur atom.
[24]

The method according to [23], wherein the metal from Groups 4 to 13 is a metal of Group 4 or 6.

[25]

The method according to [23] or [24], wherein the metal from Groups 4 to 13 is titanium of Group 4 or molybdenum of Group 6.

[26]

The method according to any one of [23] to [25], wherein the metal complex compound is a metal complex compound having at least one ligand selected from the group consisting of a β-diketonate ligand, an alkoxide ligand, a carboxylate ligand, a sulfonate ligand, and a phosphate ligand.

[27]

The method according to any one of [23] to [26], wherein the metal complex compound is a metal complex compound having at least one ligand selected from the group consisting of a β-diketonate ligand represented by the following Formula (3), an alkoxide ligand represented by the following Formula (4), a carboxylate ligand represented by the following Formula (5), a sulfonate ligand represented by the following Formula (6), and a phosphate ligand represented by the following Formula (7).

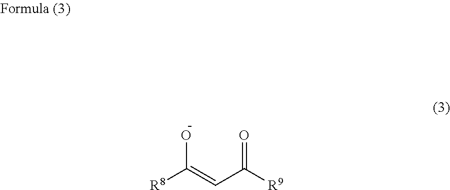

wherein R⁸ and R⁹ are the same or different, and each represents a C₁₋₂₀ hydrocarbon group optionally having at least one member selected from the group consisting of a heteroatom and a halogen atom, or a —X³R^{e}(R^{f})ₐ₃ group, wherein X³ is an oxygen atom or a nitrogen atom, a3 is 0 or 1, when X³ is an oxygen atom, a3 is 0, and when X³ is a nitrogen atom, a3 is 1; R^{e} and R^{f} are the same or different, and each represents a C₁₋₂₀ hydrocarbon group optionally containing at least one member selected from the group consisting of a heteroatom and a halogen atom; and the heteroatom is at least one member selected from the group consisting of a nitrogen atom, an oxygen atom, and a sulfur atom;

Formula (4):

R¹⁰O⁻ (4)

wherein R¹⁰ is a C₁₋₂₀ hydrocarbon group optionally having at least one member selected from the group consisting of a heteroatom, a halogen atom, a hydroxy group, and an oxyanion group (—O⁻ group); and the heteroatom is at least one member selected from the group consisting of a nitrogen atom, an oxygen atom, and a sulfur atom, and is bonded to two carbon atoms;

Formula (5):

R¹¹COO⁻ (5)

wherein R¹¹ is a C₁₋₂₀ hydrocarbon group optionally having at least one member selected from the group consisting of a heteroatom and a halogen atom; and the heteroatom is at least one member selected from the group consisting of a nitrogen atom, an oxygen atom, and a sulfur atom;

Formula (6):

R¹²SO₃⁻ (6)

wherein R¹² is a C₁₋₂₀ hydrocarbon group optionally having at least one member selected from the group consisting of a heteroatom and a halogen atom; and the heteroatom is at least one member selected from the group consisting of a nitrogen atom, an oxygen atom, and a sulfur atom; and

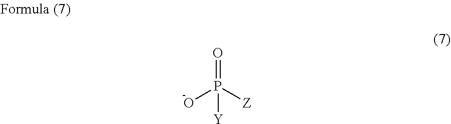

wherein Y is an oxyanion group (—O⁻ group) or OR¹³, Z is an oxyanion group (—O⁻ group) or OR¹⁴; R¹³ and R¹⁴ are the same or different, and each represents a C₁₋₂₀ hydrocarbon group or a hydrogen atom; and the heteroatom is at least one member selected from the group consisting of a nitrogen atom, an oxygen atom, and a sulfur atom, and is bonded to two carbon atoms.
[28]

The method according to any one of [23] to [27], wherein the metal complex compound is MoO₂(acac)₂, MoO₂(DPh)₂, MoO₂(NEt)₂, MoO₂(DtBu)₂, TiO(acac)₂, Ti(acac)₂(OiPr)₂, Ti(OiPr)₄, Ti(acac)₄, (Ti(OiPr)₂(OAc)₂)₂O, Ti(OiPr)₂(MeSO₃)₂, Ti(OiPr)₂(P(OBu)₂O₂)₂, Zr(acac)₄, Hf(acac)₄, Fe(acac)₃, Co(acac)₂, Ni(acac)₂, titanium octyleneglycolate, titanium ethylacetoacetate, a titanium dodecylbenzene sulfonate compound, or titanium ethanolaminate.

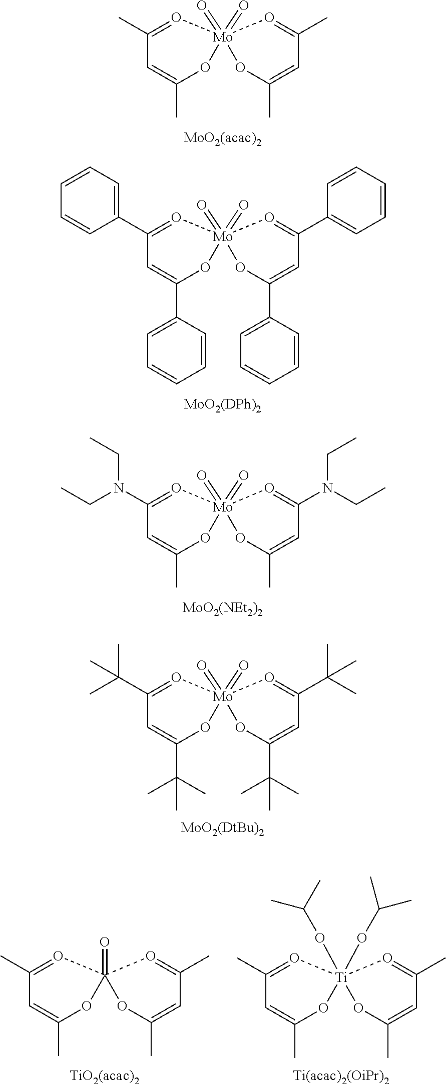

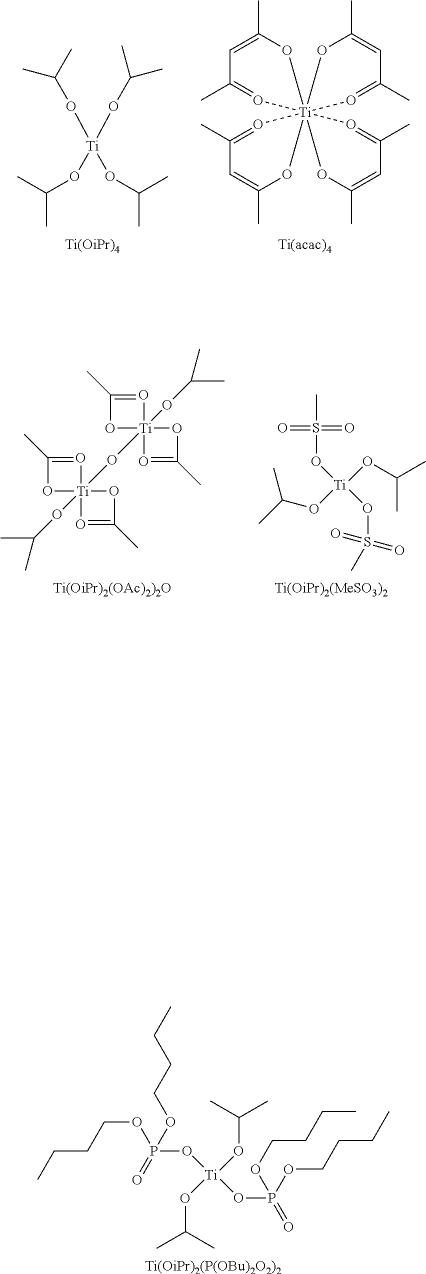

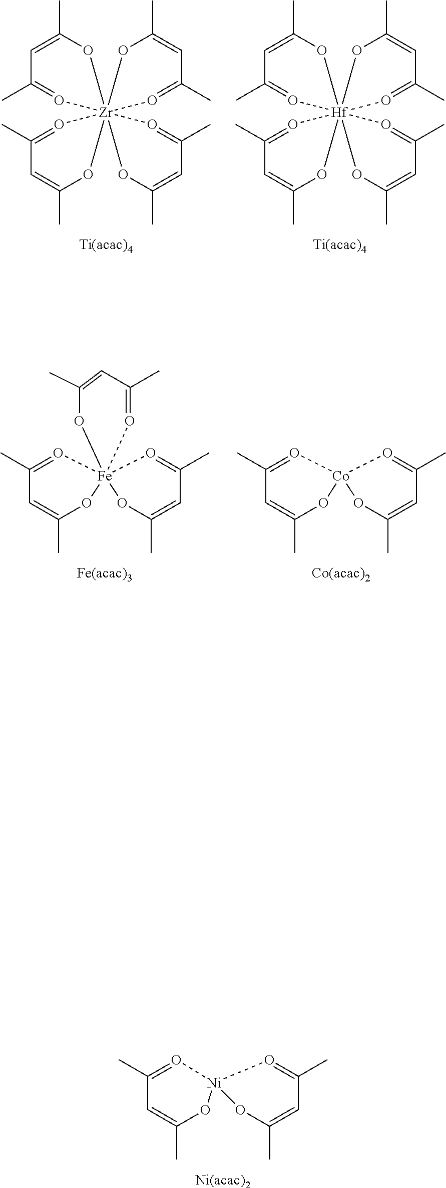

### Advantageous Effects of Invention

The present invention can provide a curing catalyst for a blocked isocyanate compound that ensures excellent low-temperature curing properties of a blocked isocyanate blocked with a nitrogen-containing compound represented by Formula (1) or Formula (2). In addition, the present invention can provide a curable composition comprising the blocked isocyanate compound and the curing catalyst for a blocked isocyanate compound and having excellent low-temperature curing properties, and also provide a cured product thereof.

### DESCRIPTION OF EMBODIMENTS

One or More Metal Complex Compounds Comprising at Least One Metal from Groups 4 to 13

In the present invention, the metal complex compound comprises at least one metal from Groups 4 to 13 and a ligand.

Examples of the metal from Groups 4 to 13 include the following, preferably metals of Groups 4, 6, and 8 to 10, and more preferably metals of Group 4 or 6.

### Group 4: Ti, Zr, Hf

### Group 5: V, Nb, Ta

### Group 6: Cr, Mo, W

### Group 7: Mn, Tc

### Group 8: Fe, Ru, Os

### Group 9: Co, Rh, Ir

### Group 10: Ni, Pd, Pt

### Group 11: Cu, Ag, Au

### Group 12: Zn, Cd, Hg

### Group 13: Ga, In, Tl

Preferred metals are Mo, Ti, Zr, Hf, Cr, W, Fe, Co, and Ni; more preferred metals are Mo, Ti, Zr, and Hf; and even more preferred metals are Mo and Ti.

The ligand is, for example, a β-diketonate ligand, an alkoxide ligand, a carboxylate ligand, a sulfonate ligand, a phosphate ligand, or the like, and it is preferable to contain at least one of these ligands. In the present invention, when the metal complex compound contains at least one of these ligands, it may further contain one or more other ligands.

The β-diketonate ligand is, for example, a ligand represented by the following Formula (3).

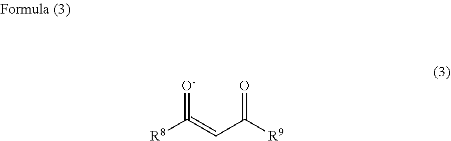

wherein R⁸ and R⁹ are the same or different, and each represents a C₁₋₂₀ hydrocarbon group optionally having at least one member selected from the group consisting of a heteroatom and a halogen atom, or a —X³R^{e}(R^{f})ₐ₃ group, wherein X³ is an oxygen atom or a nitrogen atom, a3 is 0 or 1, when X³ is an oxygen atom, a3 is 0, and when X³ is a nitrogen atom, a3 is 1; R^{e} and R^{f} are the same or different, and each represents a C₁₋₂₀ hydrocarbon group optionally containing at least one member selected from the group consisting of a heteroatom and a halogen atom; and the heteroatom is at least one member selected from the group consisting of a nitrogen atom, an oxygen atom, and a sulfur atom.

Specific examples of the β-diketonate ligand represented by Formula (3) include acetylacetonate (acac), 1,3-diphenyl-1,3-propanedionate, 1-diethylamino-3-methyl-1,3-propanedionate, 1,3-di-t-butyl-1,3-propanedionate, 1,1,1,5,5,5-hexafluoro-2,4-pentanedionate, trifluoroacetylacetonate, 2,2,6,6-tetramethyl-3,5-heptanedionate, 2,4-hexanedionate, 3,5-heptanedionate, 2-methyl-3,5-hexanedionate, 6-methyl-2,4-heptanedionate, 2,6-dimethyl-3,5-heptanedionate, 2,2-dimethyl-3,5-hexanedionate, ethylacetoacetate, N,N-diethyl-3-oxobutanamidate, and the like; and preferably acetylacetonate (acac), 1,3-diphenyl-1,3-propanedionate, and 1,3-di-t-butyl-1,3-propanedionate.

In the present specification, the alkoxide ligand refers to one obtained by removing one or more protons from one or more hydroxy groups contained in an alcohol compound and phenol molecules. The alkoxide ligand is preferably, for example, a ligand represented by the following Formula (4).

Formula (4):

R¹⁰O⁻ (4)

wherein R¹⁰ is a C₁₋₂₀ hydrocarbon group optionally having at least one member selected from the group consisting of a heteroatom, a halogen atom, a hydroxy group, and an oxyanion group (—O⁻ group); and the heteroatom is at least one member selected from the group consisting of a nitrogen atom, an oxygen atom, and a sulfur atom, and is bonded to two carbon atoms.

Examples of the alkoxide ligand represented by Formula (4) include CH₃ (CH₂)ₘ₁O⁻ (m1=an integer of 0 to 19), HO—(CH₂)ₘ₂O⁻ (m2=an integer of 1 to 20), phenoxides, and the like; and preferably CH₃(CH₂)ₘ₁O⁻ (m1=an integer of 0 to 10), HO—(CH₂)ₘ₂O⁻ (m2=an integer of 1 to 10), and (C₆H₅)O⁻. More specific examples of the alkoxide ligand include 2-hydroxyethoxide, sec-butoxide, t-butoxide, isopropoxide, methoxide, ethoxide, propoxide, butoxide, phenoxide, ethanolaminate, octylene glycolate, and the like; and preferably t-butoxide, isopropoxide, and phenoxide.

The alkoxide ligand having a hydroxy group represented by the formula HO—(CH₂)ₘ₂O⁻ (m2=an integer of 1 to 20) may also have the structure O⁻—(CH₂)ₘ₂O⁻ (m2=an integer of 1 to 20), which has multiple oxyanion groups (—O⁻ groups) as a result of dissociation of protons from hydroxy groups.

The carboxylate ligand is, for example, a ligand represented by the following Formula (5).

Formula (5):

R¹¹COO⁻ (5)

wherein R¹¹ is a C₁₋₂₀ hydrocarbon group optionally having at least one member selected from the group consisting of a heteroatom and a halogen atom; and the heteroatom is at least one member selected from the group consisting of a nitrogen atom, an oxygen atom, and a sulfur atom.

Examples of the carboxylate ligand represented by Formula (5) include CH₃(CH₂)ₘ₃COO⁻ (m3=an integer of 0 to 19), CH₃CH(CH₃)(CH₂)ₘ₄COO⁻ (m4=an integer of 0 to 17), and CF₃(CF₂)ₘ₄ₐCOO⁻ (m4a=an integer of 0 to 19); preferably CH₃(CH₂)ₘ₃COO⁻ (m3=an integer of 0 to 10), CH₃CH(CH₃)(CH₂)ₘ₄COO⁻ (m4=an integer of 0 to 10), CF₃(CF₂)ₘ₄ₐCOO⁻ (m4a=an integer of 0 to 10), and the like. Specific examples of the carboxylate ligand include acetate, propionate, butanate, 2-ethylhexanoate, octanoate, trifluoroacetate, and the like; and preferably acetate, propionate, 2-ethylhexanoate, and trifluoroacetate.

The sulfonate ligand is, for example, a ligand represented by the following Formula (6).

Formula (6):

R¹²SO₃⁻ (6)

wherein R¹² is a C₁₋₂₀ hydrocarbon group optionally having at least one member selected from the group consisting of a heteroatom and a halogen atom; and the heteroatom is at least one member selected from the group consisting of a nitrogen atom, an oxygen atom, and a sulfur atom.

Examples of the sulfonate ligand represented by Formula (6) include CH₃(CH₂)ₘ₅SO₃⁻ (m5=an integer of 0 to 19), CH₃CH(CH₃)(CH₂)ₘ₆SO₃⁻ (m6=an integer of 0 to 17), trifluoromethanesulfonate, dodecylbenzenesulfonate, methylbenzenesulfonate, and the like. Preferred examples of the sulfonate ligand include CH₃(CH₂)ₘ₅SO₃⁻ (m5=an integer of 0 to 10), CH₃CH(CH₃)(CH₂)ₘ₆SO₃⁻ (m6=an integer of 0 to 10), trifluoromethanesulfonate, dodecylbenzenesulfonate, and the like. Specific examples of the sulfonate ligand include methyl sulfonate, ethyl sulfonate, propyl sulfonate, hexyl sulfonate, octyl sulfonate, trifluoromethanesulfonate, and the like; and preferably methyl sulfonate, ethyl sulfonate, propyl sulfonate, hexyl sulfonate, and trifluoromethanesulfonate.

In the present specification, the phosphate ligand refers to one obtained by removing one or more protons from hydroxy groups contained in a phosphate ester having one or two hydroxy groups in the molecule or a phosphoric acid molecule.

The phosphate ligand is, for example, a ligand represented by the following Formula (7).

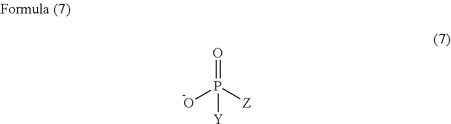

wherein Y is an oxyanion group (—O⁻ group) or OR¹³, Z is an oxyanion group (—O⁻ group) or OR¹⁴; R¹³ and R¹⁴ are the same or different, and each represents a C₁₋₂₀ hydrocarbon group optionally having at least one member selected from the group consisting of a heteroatom and a halogen atom, or a hydrogen atom; and the heteroatom is at least one member selected from the group consisting of a nitrogen atom, an oxygen atom, and a sulfur atom, and is bonded to two carbon atoms.

Examples of the phosphate ligand represented by Formula (7) include (CH₃(CH₂)ₘ₇O)₂POO⁻ (m7=an integer of 0 to 19) and phosphate (PO₄³⁻). Preferred phosphate ligands are (CH₃(CH₂)ₘ₇O)₂POO⁻ (m7=an integer of 0 to 10), phosphate, and the like.

Specific examples of the phosphate ligand include phosphate (PO₄³⁻), dimethyl phosphate, diethyl phosphate, dibutyl phosphate, dioctyl phosphate, and the like; and preferably phosphate, dimethyl phosphate, diethyl phosphate, and dibutyl phosphate.

When Y and/or Z are O⁻, protons may be added to form hydroxy groups (R¹³ and/or R¹⁴ are hydrogen atoms).

In Formula (3), R⁸ and R⁹ are the same or different, and each represents a C₁₋₂₀ hydrocarbon group optionally having at least one member selected from the group consisting of a heteroatom and a halogen atom, or a —X³R^{e}(R^{f})ₐ₃ group, wherein X³, R^{e}, R^{f}, and a3 are as defined above.

The C₁₋₂₀ hydrocarbon group optionally having at least one member selected from the group consisting of a heteroatom and a halogen atom is preferably a C₁₋₁₀ hydrocarbon group optionally having at least one member selected from the group consisting of a heteroatom and a halogen atom, and more preferably a C₁₋₆ hydrocarbon group optionally having at least one member selected from the group consisting of a heteroatom and a halogen atom.

In a preferred embodiment, the C₁₋₂₀ hydrocarbon group optionally having at least one member selected from the group consisting of a heteroatom and a halogen atom is a C₁₋₂₀ alkyl group optionally having at least one member selected from the group consisting of a heteroatom and a halogen atom, a C₆₋₂₀ aryl group optionally having at least one member selected from the group consisting of a heteroatom and a halogen atom, or a C₇₋₂₀ aralkyl group optionally having at least one member selected from the group consisting of a heteroatom and a halogen atom; preferably a C₁₋₁₀ alkyl group optionally having at least one member selected from the group consisting of a heteroatom and a halogen atom, a C₆₋₁₀ aryl group optionally having at least one member selected from the group consisting of a heteroatom and a halogen atom, or a C₇₋₁₀ aralkyl group optionally having at least one member selected from the group consisting of a heteroatom and a halogen atom; and more preferably a C₁₋₆ alkyl group optionally having at least one member selected from the group consisting of a heteroatom and a halogen atom, or a C₆ aryl group optionally having at least one member selected from the group consisting of a heteroatom and a halogen atom.

In Formula (3), when R⁸ and/or R⁹ is a —X³R^{e}(R^{f})ₐ₃ group, X³ is an oxygen atom or a nitrogen atom. a3 is 0 or 1, when X³ is an oxygen atom, a3 is 0, and when X³ is a nitrogen atom, a3 is 1.

R^{e} and R^{f} are the same or different, and each represents a C₁₋₂₀ hydrocarbon group optionally containing at least one member selected from the group consisting of a heteroatom and a halogen atom, preferably a C₁₋₁₀ hydrocarbon group optionally containing at least one member selected from the group consisting of a heteroatom and a halogen atom, and more preferably a C₁₋₆ hydrocarbon group optionally containing at least one member selected from the group consisting of a heteroatom and a halogen atom.

In a preferred embodiment, R^{e} and R^{f} are each a C₁₋₂₀ alkyl group optionally having at least one member selected from the group consisting of a heteroatom and a halogen atom, a C₆₋₂₀ aryl group optionally having at least one member selected from the group consisting of a heteroatom and a halogen atom, or a C₇₋₂₀ aralkyl group optionally having at least one member selected from the group consisting of a heteroatom and a halogen atom; preferably a C₁₋₁₀ alkyl group optionally having at least one member selected from the group consisting of a heteroatom and a halogen atom, a C₆₋₁₀ aryl group optionally having at least one member selected from the group consisting of a heteroatom and a halogen atom, or a C₇₋₁₀ aralkyl group optionally having at least one member selected from the group consisting of a heteroatom and a halogen atom; and more preferably a C₁₋₆ alkyl group optionally having at least one member selected from the group consisting of a heteroatom and a halogen atom, or a C₆ aryl group optionally having at least one member selected from the group consisting of a heteroatom and a halogen atom.

In R^{e} and R^{f}, examples of the “C₁₋₂₀ hydrocarbon group” include methyl, ethyl, propyl, isopropyl, butyl, sec-butyl, tert-butyl, pentyl, hexyl, heptyl, octyl, nonyl, decyl, dodecyl, octadecyl, cyclopropyl, cyclopentyl, cyclohexyl, phenyl, naphthyl, benzyl, phenethyl, tolyl, and allyl groups; preferably methyl, ethyl, propyl, isopropyl, butyl, sec-butyl, tert-butyl, pentyl, hexyl, heptyl, octyl, nonyl, decyl, benzyl, and phenyl groups; more preferably methyl, ethyl, propyl, isopropyl, butyl, sec-butyl, tert-butyl, benzyl, and phenyl groups; and even more preferably methyl, ethyl, and tert-butyl groups.

In R^{e} and R^{f}, examples of the “C₁₋₂₀ alkyl group” include methyl, ethyl, propyl, isopropyl, butyl, sec-butyl, tert-butyl, pentyl, hexyl, heptyl, octyl, and 2-ethylhexyl groups; and preferably methyl, ethyl, isopropyl, and tert-butyl groups.

In R^{e} and R^{f}, examples of the “C₆₋₂₀ aryl group” include phenyl, naphthyl, and tolyl groups; preferably phenyl and tolyl groups; and more preferably a phenyl group.

In R^{e} and R^{f}, examples of the “aralkyl group” include benzyl, p-methylbenzyl, p-octylbenzyl, p-decylbenzyl, p-dodecylbenzyl, and p-phenylbenzyl groups; and preferably benzyl and p-methylbenzyl groups.

In R^{e} and R^{f}, when the C₁₋₂₀ hydrocarbon group optionally containing at least one member selected from the group consisting of a heteroatom and a halogen atom contains a heteroatom, examples of the heteroatom include an oxygen atom, a nitrogen atom, and a sulfur atom, and the number of heteroatoms is preferably 1 to 5, more preferably 1 to 3, and even more preferably 1 or 2. The hydrocarbon group may contain one type of heteroatom, or two or three types of heteroatoms. When the hydrocarbon group contains at least one heteroatom, such as an oxygen atom, a nitrogen atom, or a sulfur atom, the hydrocarbon group has at least one group, such as —O—, —N<, —NH—, —S—, or —SO₂—, and the hydrocarbon chain may be interrupted by such a group.

In R^{e} and R^{f}, when the C₁₋₂₀ hydrocarbon group optionally containing at least one member selected from the group consisting of a heteroatom and a halogen atom contains a halogen atom, examples of the halogen include a fluorine atom, a chlorine atom, a bromine atom, an iodine atom, and the like. The number of halogen atoms is preferably 1 to 5, more preferably 1 to 3, and even more preferably 1 or 2. The hydrocarbon group may contain one type of halogen atom, or two or three types of halogen atoms.

In R⁸ and R⁹ of Formula (3), examples of the “C₁₋₂₀ hydrocarbon group” include methyl, ethyl, propyl, isopropyl, butyl, sec-butyl, tert-butyl, pentyl, hexyl, heptyl, octyl, nonyl, decyl, dodecyl, octadecyl, cyclopropyl, cyclopentyl, cyclohexyl, phenyl, naphthyl, benzyl, phenethyl, tolyl, and allyl groups; preferably methyl, ethyl, propyl, isopropyl, butyl, sec-butyl, tert-butyl, pentyl, hexyl, heptyl, octyl, nonyl, decyl, benzyl, and phenyl groups; more preferably methyl, ethyl, propyl, isopropyl, butyl, sec-butyl, tert-butyl, benzyl, and phenyl groups; and even more preferably methyl, ethyl, and tert-butyl groups.

In R⁸ and R⁹, examples of the “C₁₋₂₀ alkyl group” include methyl, ethyl, propyl, isopropyl, butyl, sec-butyl, tert-butyl, pentyl, hexyl, heptyl, octyl, nonyl, decyl, dodecyl, and octadecyl groups; preferably methyl, ethyl, propyl, isopropyl, butyl, sec-butyl, tert-butyl, pentyl, hexyl, heptyl, octyl, nonyl, and decyl groups; more preferably methyl, ethyl, propyl, isopropyl, butyl, sec-butyl, and tert-butyl groups; and even more preferably methyl, ethyl, and tert-butyl groups.

In R⁸ and R⁹, examples of the “C₆₋₂₀ aryl group” include phenyl, naphthyl, and tolyl groups; preferably phenyl and tolyl groups; and more preferably a phenyl group.

In R⁸ and R⁹, examples of the “C₇₋₂₀ aralkyl group” include benzyl, p-methylbenzyl, p-octylbenzyl, p-decylbenzyl, p-dodecylbenzyl, and p-phenylbenzyl groups; and preferably benzyl and p-methylbenzyl groups.

In R⁸ and R⁹, when the C₁₋₂₀ hydrocarbon group optionally containing at least one member selected from the group consisting of a heteroatom and a halogen atom contains a heteroatom, examples of the heteroatom include an oxygen atom, a nitrogen atom, and a sulfur atom, and the number of heteroatoms is preferably 1 to 5, more preferably 1 to 3, and even more preferably 1 or 2. The hydrocarbon group may contain one type of heteroatom, or two or three types of heteroatoms. When the hydrocarbon group contains at least one heteroatom, such as an oxygen atom, a nitrogen atom, or a sulfur atom, the hydrocarbon group has at least one group, such as —O—, —N<, —NH—, —S—, or —SO₂—, and the hydrocarbon chain may be interrupted by such a group.

In R⁸ and R⁹, when the C₁₋₂₀ hydrocarbon group optionally containing at least one member selected from the group consisting of a heteroatom and a halogen atom contains a halogen atom, examples of the halogen include a fluorine atom, a chlorine atom, a bromine atom, an iodine atom, and the like. The number of halogen atoms is preferably 1 to 5, more preferably 1 to 3, and even more preferably 1 or 2. The hydrocarbon group may contain one type of halogen atom, or two or three types of halogen atoms.

In Formula (4), R¹⁰ represents a C₁₋₂₀ hydrocarbon group optionally having at least one member selected from the group consisting of a heteroatom, a halogen atom, a hydroxy group, and an oxyanion group (—O⁻ group); preferably a C₁₋₁₀ hydrocarbon group optionally having at least one member selected from the group consisting of a heteroatom, a halogen atom, a hydroxy group, and an oxyanion group (—O⁻ group); and more preferably a C₁₋₆ hydrocarbon group optionally having at least one member selected from the group consisting of a heteroatom, a halogen atom, a hydroxy group, and an oxyanion group (—O⁻ group).

In this case, in a preferred embodiment, R¹⁰ is a C₁₋₂₀ alkyl group optionally having at least one member selected from the group consisting of a heteroatom, a halogen atom, a hydroxy group, and an oxyanion group (—O⁻ group); or a C₆₋₂₀ aryl group optionally having at least one member selected from the group consisting of a heteroatom, a halogen atom, a hydroxy group, and an oxyanion group (—O⁻ group); or a C₇₋₂₀ aralkyl group optionally having at least one member selected from the group consisting of a heteroatom, a halogen atom, a hydroxy group, and an oxyanion group (—O⁻ group). Preferably, R¹⁰ is a C₁₋₁₀ alkyl group optionally having at least one member selected from the group consisting of a heteroatom, a halogen atom, a hydroxy group, and an oxyanion group (—O⁻ group); a C₆₋₁₀ aryl group optionally having at least one member selected from the group consisting of a halogen atom, a heteroatom, a hydroxy group, and an oxyanion group (—O⁻ group); or a C₇₋₁₀ aralkyl group optionally having at least one member selected from the group consisting of a heteroatom, a halogen atom, a hydroxy group, and an oxyanion group (—O⁻ group). More preferably, R¹⁰ is a C₁₋₆ alkyl group optionally having at least one member selected from the group consisting of a heteroatom, a halogen atom, a hydroxy group, and an oxyanion group (—O⁻ group); or a C₆ aryl group optionally having at least one member selected from the group consisting of a heteroatom, a halogen atom, a hydroxy group, and an oxyanion group (—O⁻ group).

In R¹⁰ of Formula (4), examples of the “C₁₋₂₀ hydrocarbon group” include methyl, ethyl, propyl, isopropyl, butyl, sec-butyl, tert-butyl, pentyl, hexyl, heptyl, octyl, nonyl, decyl, dodecyl, octadecyl, cyclopropyl, cyclopentyl, cyclohexyl, phenyl, naphthyl, benzyl, phenethyl, tolyl, and allyl groups; preferably methyl, ethyl, propyl, isopropyl, butyl, sec-butyl, tert-butyl, pentyl, hexyl, heptyl, octyl, nonyl, decyl, cyclopropyl, cyclopentyl, cyclohexyl, phenyl, benzyl, tolyl, and allyl groups; more preferably methyl, ethyl, propyl, isopropyl, butyl, sec-butyl, and tert-butyl groups; and even more preferably an isopropyl group.

In R¹⁰, examples of the “C₁₋₂₀ alkyl group” include methyl, ethyl, propyl, isopropyl, butyl, sec-butyl, tert-butyl, pentyl, hexyl, heptyl, octyl, nonyl, decyl, dodecyl, and octadecyl groups; preferably methyl, ethyl, propyl, isopropyl, butyl, sec-butyl, tert-butyl, pentyl, hexyl, heptyl, octyl, nonyl, and decyl groups; more preferably methyl, ethyl, propyl, isopropyl, butyl, sec-butyl, and tert-butyl groups; and even more preferably an isopropyl group.

In R¹⁰, examples of the “C₆₋₂₀ aryl group” include phenyl, naphthyl, and tolyl groups; preferably phenyl and tolyl groups; and more preferably a phenyl group.

In R¹⁰, examples of the “C₇₋₂₀ aralkyl group” include benzyl, p-methylbenzyl, p-octylbenzyl, p-decylbenzyl, p-dodecylbenzyl, p-tetradecylbenzyl, and p-phenylbenzyl groups; and preferably benzyl and p-methylbenzyl groups.

When the C₁₋₂₀ hydrocarbon group optionally having at least one member selected from the group consisting of a heteroatom, a halogen atom, a hydroxy group, and an oxyanion group (—O⁻ group) represented by R¹⁰ contains a heteroatom, examples of the heteroatom include an oxygen atom, a nitrogen atom, and a sulfur atom, and the number of heteroatoms is preferably 1 to 5, more preferably 1 to 3, and even more preferably 1 or 2. The hydrocarbon group may contain one type of heteroatom, or two or three types of heteroatoms. When the C₁₋₂₀ hydrocarbon group optionally having at least one member selected from the group consisting of a heteroatom, a halogen atom, a hydroxy group, and an oxyanion group (—O⁻ group) contains at least one heteroatom, such as an oxygen atom, a nitrogen atom, or a sulfur atom, the hydrocarbon group has at least one group, such as —O—, —N<, —NH—, —S—, or —SO₂—, and the hydrocarbon chain may be interrupted by such a group.

When the C₁₋₂₀ hydrocarbon group optionally having at least one member selected from the group consisting of a heteroatom, a halogen atom, a hydroxy group, and an oxyanion group (—O⁻ group) represented by R¹⁰ contains a halogen atom, examples of the halogen include a fluorine atom, a chlorine atom, a bromine atom, an iodine atom, and the like. The number of halogen atoms is preferably 1 to 5, more preferably 1 to 3, and even more preferably 1 or 2. The hydrocarbon group may contain one type of halogen atom, or two or three types of halogen atoms.

Examples of the C₁₋₂₀ hydrocarbon group optionally having at least one member selected from the group consisting of a heteroatom, a halogen atom, a hydroxy group, and an oxyanion group (—O⁻ group) represented by R¹⁰ include a C₁₋₂₀ ω-hydroxyalkyl group, a C₁₋₂₀ ω-hydroxyalkoxyalkyl group, a C₆₋₂₀ hydroxyaryl group, and the like.

The C₆₋₂₀ hydroxyaryl group is preferably, for example, a hydroxyaryl group represented by the following Formula (j).

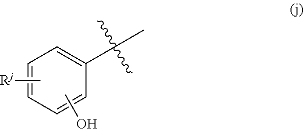

wherein R^{j} is a C₁₋₈ alkyl group or a hydrogen atom.

In R^{j}, examples of the “C₁₋₈ alkyl group” include methyl, ethyl, propyl, isopropyl, butyl, sec-butyl, tert-butyl, pentyl, hexyl, heptyl, and octyl groups.

When the C₁₋₂₀ hydrocarbon group optionally having at least one member selected from the group consisting of a heteroatom, a halogen atom, a hydroxy group, and an oxyanion group (—O⁻ group) represented by R¹⁰ has a hydroxy group, protons of some or all of the hydroxy groups of the C₁₋₂₀ hydrocarbon group having a hydroxy group may be dissociated to form oxyanion groups (—O⁻ groups). In this case, some or all of the oxyanion groups (—O⁻ groups) may be bonded to the metal atom of the metal complex compound.

In Formula (5), R¹¹ represents a C₁₋₂₀ hydrocarbon group optionally having at least one member selected from the group consisting of a heteroatom and a halogen atom, preferably a C₁₋₁₀ hydrocarbon group optionally having at least one member selected from the group consisting of a heteroatom and a halogen atom, and more preferably a C₁₋₆ hydrocarbon group optionally having at least one member selected from the group consisting of a heteroatom and a halogen atom. In this case, in a preferred embodiment, R¹¹ is a C₁₋₂₀ alkyl group optionally having at least one member selected from the group consisting of a heteroatom and a halogen atom, a C₆₋₂₀ aryl group optionally having at least one member selected from the group consisting of a heteroatom and a halogen atom, or a C₇₋₂₀ aralkyl group optionally having at least one member selected from the group consisting of a heteroatom and a halogen atom; preferably a C₁₋₁₀ alkyl group optionally having at least one member selected from the group consisting of a heteroatom and a halogen atom, a C₆₋₁₀ aryl group optionally having at least one member selected from the group consisting of a heteroatom and a halogen atom, or a C₇₋₁₀ aralkyl group optionally having at least one member selected from the group consisting of a heteroatom and a halogen atom; and more preferably a C₁₋₆ alkyl group optionally having at least one member selected from the group consisting of a heteroatom and a halogen atom, or a C₆ aryl group optionally having at least one member selected from the group consisting of a heteroatom and a halogen atom.

In R¹¹, examples of the “C₁₋₂₀ hydrocarbon group” include methyl, ethyl, propyl, isopropyl, butyl, sec-butyl, tert-butyl, pentyl, hexyl, heptyl, octyl, nonyl, decyl, dodecyl, octadecyl, cyclopropyl, cyclopentyl, cyclohexyl, phenyl, naphthyl, benzyl, phenethyl, tolyl, and allyl groups; preferably methyl, ethyl, propyl, isopropyl, butyl, sec-butyl, tert-butyl, pentyl, hexyl, heptyl, octyl, nonyl, decyl, cyclopropyl, cyclopentyl, cyclohexyl, phenyl, benzyl, tolyl, and allyl groups; and more preferably methyl, ethyl, propyl, isopropyl, butyl, sec-butyl, tert-butyl, pentyl, hexyl, and phenyl groups.

In R¹¹, examples of the “C₁₋₂₀ alkyl group” include methyl, ethyl, propyl, isopropyl, butyl, sec-butyl, tert-butyl, pentyl, hexyl, heptyl, octyl, nonyl, decyl, dodecyl, and octadecyl groups; preferably methyl, ethyl, propyl, isopropyl, butyl, sec-butyl, tert-butyl, pentyl, hexyl, heptyl, octyl, nonyl, and decyl groups; and more preferably methyl, ethyl, propyl, isopropyl, butyl, sec-butyl, tert-butyl, pentyl, and hexyl groups.

In R¹¹, examples of the “C₆₋₂₀ aryl group” include phenyl, naphthyl, and tolyl groups; preferably phenyl and tolyl groups; and more preferably a phenyl group.

In R¹¹, examples of the “C₇₋₂₀ aralkyl group” include benzyl, p-methylbenzyl, p-octylbenzyl, p-decylbenzyl, p-dodecylbenzyl, and p-phenylbenzyl groups; and preferably benzyl and p-methylbenzyl groups.

When the C₁₋₂₀ hydrocarbon group optionally containing at least one member selected from the group consisting of a heteroatom and a halogen atom represented by R¹¹ contains a heteroatom, examples of the heteroatom include an oxygen atom, a nitrogen atom, and a sulfur atom, and the number of heteroatoms is preferably 1 to 5, more preferably 1 to 3, and even more preferably 1 or 2. The hydrocarbon group may contain one type of heteroatom, or two or three types of heteroatoms. When the hydrocarbon group contains at least one heteroatom, such as an oxygen atom, a nitrogen atom, or a sulfur atom, the hydrocarbon group has at least one group, such as —O—, —N<, —NH—, —S—, or —SO₂—, and the hydrocarbon chain may be interrupted by such a group.

When the C₁₋₂₀ hydrocarbon group optionally containing at least one member selected from the group consisting of a heteroatom and a halogen atom represented by R¹¹ contains a halogen atom, examples of the halogen include a fluorine atom, a chlorine atom, a bromine atom, an iodine atom, and the like. The number of halogen atoms is preferably 1 to 5, more preferably 1 to 3, and even more preferably 1 or 2. The hydrocarbon group may contain one type of halogen atom, or two or three types of halogen atoms.

In Formula (6), R¹² represents a C₁₋₂₀ hydrocarbon group optionally having at least one member selected from the group consisting of a heteroatom and a halogen atom, preferably a C₁₋₁₀ hydrocarbon group optionally having at least one member selected from the group consisting of a heteroatom and a halogen atom, and more preferably a C₁₋₆ hydrocarbon group optionally having at least one member selected from the group consisting of a heteroatom and a halogen atom.

In this case, in a preferred embodiment, R¹² is a C₁₋₂₀ alkyl group optionally having at least one member selected from the group consisting of a heteroatom and a halogen atom, a C₆₋₂₀ aryl group optionally having at least one member selected from the group consisting of a heteroatom and a halogen atom, or a C₇₋₂₀ aralkyl group optionally having at least one member selected from the group consisting of a heteroatom and a halogen atom; preferably a C₁₋₁₀ alkyl group optionally having at least one member selected from the group consisting of a heteroatom and a halogen atom, a C₆₋₁₀ aryl group optionally having at least one member selected from the group consisting of a heteroatom and a halogen atom, or a C₇₋₁₀ aralkyl group optionally having at least one member selected from the group consisting of a heteroatom and a halogen atom; and more preferably a C₁₋₆ alkyl group or a C₆ aryl group.

In R¹² of Formula (6), examples of the “C₁₋₂₀, hydrocarbon group” include methyl, ethyl, propyl, isopropyl, butyl, sec-butyl, tert-butyl, pentyl, hexyl, heptyl, octyl, nonyl, decyl, dodecyl, octadecyl, cyclopropyl, cyclopentyl, cyclohexyl, phenyl, naphthyl, benzyl, phenethyl, tolyl, allyl, and p-dodecylbenzyl groups; preferably methyl, ethyl, propyl, isopropyl, butyl, sec-butyl, tert-butyl, pentyl, hexyl, heptyl, octyl, nonyl, decyl, dodecyl, cyclopropyl, cyclopentyl, cyclohexyl, phenyl, naphthyl, benzyl, tolyl, allyl, and p-dodecylbenzyl groups; more preferably methyl, ethyl, propyl, isopropyl, butyl, sec-butyl, tert-butyl, pentyl, hexyl, phenyl, naphthyl, benzyl, and p-dodecylbenzyl groups; and even more preferably methyl and p-dodecylbenzyl groups.

In R¹², examples of the “C₁₋₂₀ alkyl group” include methyl, ethyl, propyl, isopropyl, butyl, sec-butyl, tert-butyl, pentyl, hexyl, heptyl, octyl, nonyl, decyl, dodecyl, and octadecyl groups; preferably methyl, ethyl, propyl, isopropyl, butyl, sec-butyl, tert-butyl, pentyl, hexyl, heptyl, octyl, nonyl, and decyl groups; more preferably methyl, ethyl, propyl, isopropyl, butyl, sec-butyl, tert-butyl, pentyl, and hexyl groups; and even more preferably a methyl group.

In R¹², examples of the “C₆₋₂₀ aryl group” include phenyl, naphthyl, and tolyl groups; preferably phenyl and tolyl groups; and more preferably a phenyl group.

In R¹², examples of the “C₇₋₂₀ aralkyl group” include benzyl, p-methylbenzyl, p-octylbenzyl, p-decylbenzyl, p-dodecylbenzyl, and p-phenylbenzyl groups; and preferably benzyl and p-methylbenzyl groups.

When the C₁₋₂₀ hydrocarbon group optionally containing at least one member selected from the group consisting of a heteroatom and a halogen atom represented by R¹² contains a heteroatom, examples of the heteroatom include an oxygen atom, a nitrogen atom, and a sulfur atom, and the number of heteroatoms is preferably 1 to 5, more preferably 1 to 3, and even more preferably 1 or 2. The hydrocarbon group may contain one type of heteroatom, or two or three types of heteroatoms. When the hydrocarbon group contains at least one heteroatom, such as an oxygen atom, a nitrogen atom, or a sulfur atom, the hydrocarbon group has at least one group, such as —O—, —N<, —NH—, —S—, or —SO₂—, and the hydrocarbon chain may be interrupted by such a group.

When the C₁₋₂₀ hydrocarbon group optionally containing at least one member selected from the group consisting of a heteroatom and a halogen atom represented by R¹² contains a halogen atom, examples of the halogen include a fluorine atom, a chlorine atom, a bromine atom, an iodine atom, and the like. The number of halogen atoms is preferably 1 to 5, more preferably 1 to 3, and even more preferably 1 or 2. The hydrocarbon group may contain one type of halogen atom, or two or three types of halogen atoms.

In Formula (7), R¹³ and R¹⁴ each represent a C₁₋₂₀ hydrocarbon group optionally having at least one member selected from the group consisting of a heteroatom and a halogen atom, preferably a C₁₋₁₀ hydrocarbon group optionally having at least one member selected from the group consisting of a heteroatom and a halogen atom, and more preferably a C₁₋₆ hydrocarbon group optionally having at least one member selected from the group consisting of a heteroatom and a halogen atom.

In this case, in a preferred embodiment, R¹³ and R¹⁴ are each a C₁₋₂₀ alkyl group optionally having at least one member selected from the group consisting of a heteroatom and a halogen atom, a C₆₋₂₀ aryl group optionally having at least one member selected from the group consisting of a heteroatom and a halogen atom, or a C₇₋₂₀ aralkyl group optionally having at least one member selected from the group consisting of a heteroatom and a halogen atom; preferably a C₁₋₁₀ alkyl group optionally having at least one member selected from the group consisting of a heteroatom and a halogen atom, a C₆₋₁₀ aryl group optionally having a heteroatom or a halogen atom, or a C₇₋₁₀ aralkyl group optionally having a heteroatom or a halogen atom; and more preferably a C₁₋₆ alkyl group optionally having at least one member selected from the group consisting of a heteroatom and a halogen atom, or a C₆ aryl group optionally having at least one member selected from the group consisting of a heteroatom and a halogen atom.

In R¹³ and R¹⁴, examples of the “C₁₋₂₀ hydrocarbon group” include methyl, ethyl, propyl, isopropyl, butyl, sec-butyl, tert-butyl, pentyl, hexyl, heptyl, octyl, nonyl, decyl, dodecyl, octadecyl, cyclopropyl, cyclopentyl, cyclohexyl, phenyl, naphthyl, benzyl, phenethyl, tolyl, and allyl groups; preferably methyl, ethyl, propyl, isopropyl, butyl, sec-butyl, tert-butyl, pentyl, hexyl, heptyl, octyl, nonyl, decyl, dodecyl, cyclopropyl, cyclopentyl, cyclohexyl, phenyl, naphthyl, benzyl, tolyl, and allyl groups; more preferably methyl, ethyl, propyl, isopropyl, butyl, sec-butyl, tert-butyl, pentyl, hexyl, and phenyl groups; and even more preferably a butyl group.

In R¹³ and R¹⁴, examples of the “C₁₋₂₀ alkyl group” include methyl, ethyl, propyl, isopropyl, butyl, sec-butyl, tert-butyl, pentyl, hexyl, heptyl, octyl, nonyl, decyl, dodecyl, octadecyl, and allyl groups; preferably methyl, ethyl, propyl, isopropyl, butyl, sec-butyl, tert-butyl, pentyl, hexyl, heptyl, octyl, nonyl, and decyl groups; more preferably methyl, ethyl, propyl, isopropyl, butyl, sec-butyl, tert-butyl, pentyl, and hexyl groups; and even more preferably a butyl group.

In R¹³ and R¹⁴, examples of the “C₆₋₂₀ aryl group” include phenyl, naphthyl, and tolyl groups; preferably phenyl and tolyl groups; and more preferably a phenyl group.

In R¹³ and R¹⁴, examples of the “C₇₋₂₀ aralkyl group” include benzyl, p-methylbenzyl, p-octylbenzyl, p-decylbenzyl, p-dodecylbenzyl, and p-phenylbenzyl groups; and preferably benzyl and p-methylbenzyl groups.

When the C₁₋₂₀ hydrocarbon group optionally containing at least one member selected from the group consisting of a heteroatom and a halogen atom represented by R¹³ or R¹⁴ contains a heteroatom, examples of the heteroatom include an oxygen atom, a nitrogen atom, and a sulfur atom, and the number of heteroatoms is preferably 1 to 5, more preferably 1 to 3, and even more preferably 1 or 2. The hydrocarbon group may contain one type of heteroatom, or two or three types of heteroatoms. When the hydrocarbon group contains at least one heteroatom, such as an oxygen atom, a nitrogen atom, or a sulfur atom, the hydrocarbon group has at least one group, such as —O—, —N<, —NH—, —S—, or —SO₂—, and the hydrocarbon chain may be interrupted by such a group.

When the C₁₋₂₀ hydrocarbon group optionally containing at least one member selected from the group consisting of a heteroatom and a halogen atom represented by R¹³ or R¹⁴ contains a halogen atom, examples of the halogen include a fluorine atom, a chlorine atom, a bromine atom, an iodine atom, and the like. The number of halogen atoms is preferably 1 to 5, more preferably 1 to 3, and even more preferably 1 or 2. The hydrocarbon group may contain one type of halogen atom, or two or three types of halogen atoms.

The ligand is preferably a β-diketonate ligand represented by Formula (3), an alkoxide ligand represented by Formula (4), a carboxylate ligand represented by Formula (5), a sulfonate ligand represented by Formula (6), or a phosphate ligand represented by Formula (7). The ligand is more preferably a β-diketonate ligand represented by Formula (3) or an alkoxide ligand represented by Formula (4). The ligand is even more preferably any of the following ligands.

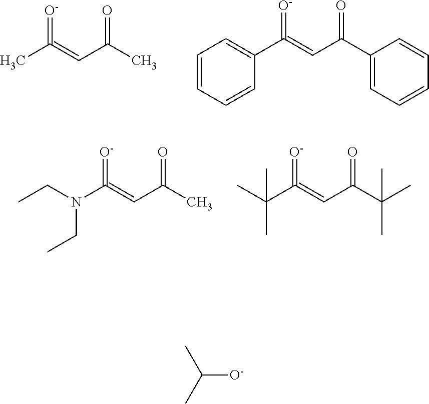

The metal complex compound of the present invention may be further coordinated by a ligand other than those above. Examples of such a ligand other than those above include a carbene ligand, a phosphine ligand, a pyridine ligand, and the like.

The metal complex compound of the present invention may be a commercial product or may be produced by a known method, and can be produced, for example, by a production method described below.

The metal complex compound of the present invention can be obtained by mixing and stirring a metal compound from Groups 4 to 13 and a ligand mentioned above or/and a protonated compound of the ligand in the presence of at least one solvent selected from water, methanol, ethanol, isopropanol, n-butanol, t-butanol, acetone, tetrahydrofuran, diethyl ether, dioxane, acetonitrile, toluene, xylene, and the like at a temperature of about 0 to 100° C. for about 1 to 24 hours.

The ligand can be preferably used in an amount of about 1 to 8 mol per mol of the metal compound from Groups 4 to 13.

Examples of the metal compound from Groups 4 to 13 include fluoride, chloride, bromide, iodide, hydroxide, oxide, carbonate, acetate, nitrate, sulfate, and the like of metals of Groups 4 to 13.

The reaction may be performed, if necessary, in an inert gas atmosphere, such as nitrogen, argon, or helium, which do not affect the reaction.

After completion of the reaction, the metal complex compound can be obtained by removing the solvent by concentrating, separating, or filtering the reaction liquid, and may be purified by recrystallization, column separation, etc., if necessary. Alternatively, the reaction liquid may be directly mixed into the curable composition without removing the solvent.

Specific examples of the metal complex compound of the present invention include MoO₂(acac)₂, MoO₂(DPh)₂, MoO₂(NEt₂)₂, MoO₂(DtBu)₂, TiO(acac)₂, Ti(acac)₂(OiPr)₂, Ti(OiPr)₄, Ti(acac)₄, (Ti(OiPr)₂(OAc) 2)₂O, Ti(OiPr)₂(MeSO₃)₂, Ti(OiPr)₂(P(OBu)₂O₂)₂, Zr(acac)₄, Hf(acac)₄, Fe(acac)₃, Co(acac)₂, Ni(acac)₂, titanium octyleneglycolate, titanium ethylacetoacetate, a titanium dodecylbenzene sulfonate compound, titanium ethanolaminate, and the like.

Preferred metal complex compounds are MoO₂(acac), MoO₂(DPh)₂, MoO₂(NEt₂)₂, MoO₂ (DtBu)₂, TiO (acac)₂, Ti(acac)₂(OiPr)₂, Ti(OiPr)₄, Ti(acac)₄, (Ti(OiPr)₂(OAc)₂)₂O, Ti(OiPr)₂(MeSO₃)₂, and Ti(OiPr)₂(P(OBu)₂O₂)₂. More preferred are MoO₂(acac)₂, MoO₂(DPh)₂, MoO₂(NEt₂)₂, MoO₂(DtBu)₂, TiO(acac)₂, Ti(acac)₂(OiPr)₂, Ti(OiPr)₄, Ti(acac)₄, and Ti(OiPr)₂(MeSO₃)₂.

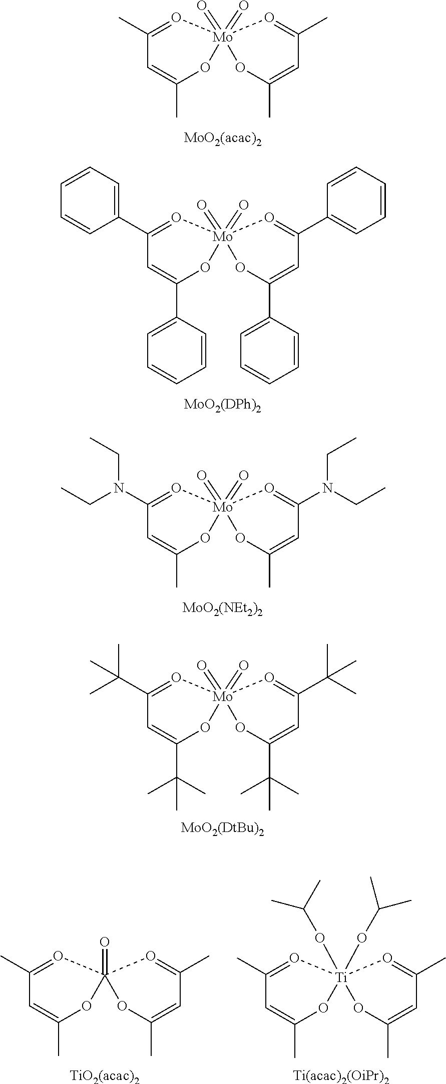

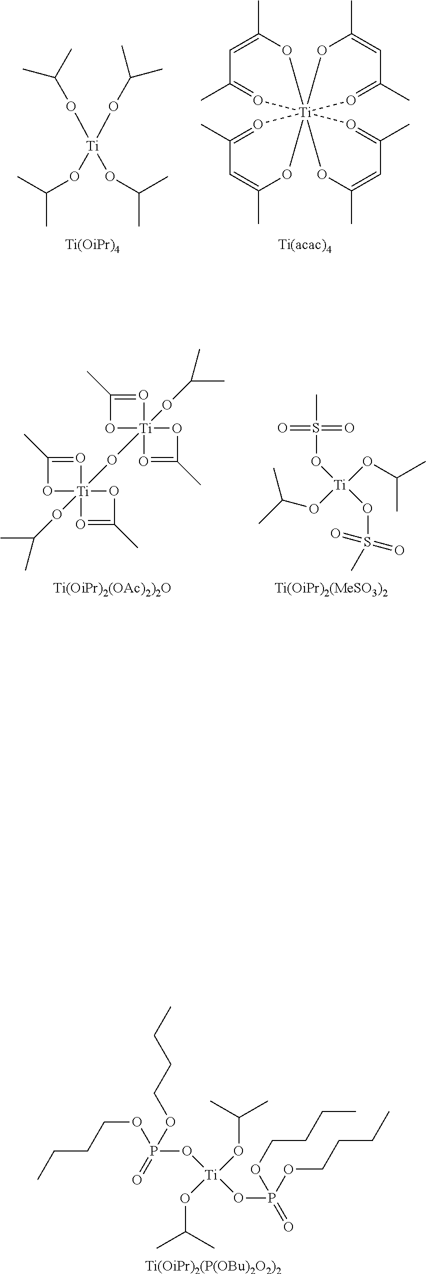

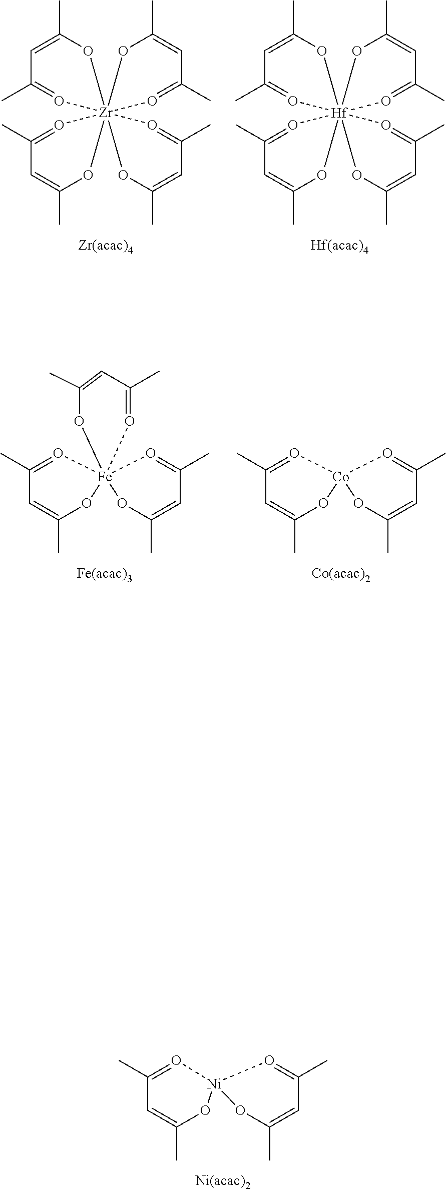

The metal complex compound of the present invention can be suitably used as a curing catalyst for a blocked isocyanate compound described below.

### Blocked Isocyanate Compound

The blocked isocyanate compound refers to a compound having a structure in which an isocyanate group in an isocyanate compound is blocked with a blocking agent.

In the present specification, examples of the isocyanate compound include the following isocyanates (i) to (v):
(i) aliphatic polyisocyanates,
(ii) alicyclic polyisocyanates,
(iii) aromatic polyisocyanates,
(iv) aromatic aliphatic polyisocyanates, and
(v) modified isocyanates formed from at least one member selected from the group consisting of aliphatic polyisocyanates, alicyclic polyisocyanates, aromatic polyisocyanates, and aromatic aliphatic polyisocyanates.

Preferred among these are the aliphatic polyisocyanates (i), alicyclic polyisocyanates (ii), and modified isocyanates (v) formed from at least one member selected from the group consisting of aliphatic polyisocyanates, alicyclic polyisocyanates, aromatic polyisocyanates, and aromatic aliphatic polyisocyanates.

These isocyanate compounds may be used singly or as a mixture of two or more.

Examples of aliphatic polyisocyanates include 1,4-tetramethylene diisocyanate, 1,6-hexamethylene diisocyanate, 2,2,4-ttrimethylhexamethylene diisocyanate, 2,4,4-trimethylhexamethylene diisocyanate, lysine diisocyanate, dimer acid diisocyanate, and the like.

Examples of alicyclic polyisocyanates include 1,3-bis(isocyanatomethyl)cyclohexane, 1,4-bis(isocyanatomethyl)cyclohexane, 3-isocyanatomethyl-3,3,5-trimethylcyclohexane (isophorone diisocyanate), bis-(4-isocyanatocyclohexyl)methane, norbornane diisocyanate, and the like.

Examples of aromatic polyisocyanates include 2,4′-diphenylmethane diisocyanate, 4,4′-diphenylmethane diisocyanate, crude diphenylmethane diisocyanate, 1,4-phenylene diisocyanate, 2,4-tolylene diisocyanate, 2,6-tolylene diisocyanate, 3,3′-dimethyl-4,4′-diisocyanatobiphenyl, 3,3′-dimethyl-4,4′-diisocyanatodiphenylmethane, 1,5-naphthylene diisocyanate, and the like.

Examples of aromatic aliphatic polyisocyanates include 1,3-xylylene diisocyanate, 1,4-xylylene diisocyanate, α,α,α′,α,α′-tetramethylxylylene diisocyanate, and the like.

Examples of modified polyisocyanates include isocyanate-terminated compounds obtained by the reaction of the above polyisocyanate compounds with compounds having an active hydrogen group, and reaction products of the polyisocyanate compounds and/or the isocyanate-terminated compounds (e.g., adduct-type polyisocyanates, and modified isocyanates obtained by allophanatization reaction, carbodiimidization reaction, uretodionization reaction, isocyanuration reaction, uretoniminization reaction, biuretization reaction, or the like); and preferably adduct-type polyisocyanates, polyisocyanates modified by isocyanuration reaction, and polyisocyanates modified by biuretization reaction (polyisocyanates having a biuret bond).

A polyisocyanate having a biuret bond is obtained by reacting a so-called biuretizing agent, such as water, tert-butanol, or urea, with a polyisocyanate at a molar ratio of the biuretizing agent/isocyanate groups in the polyisocyanate of about ½ to about 1/100, followed by purification by removing the unreacted polyisocyanate. A polyisocyanate having an isocyanurate bond is obtained, for example, by performing the cyclic trimerization reaction using a catalyst etc., stopping the reaction when the conversion rate reaches about 5 to about 80 mass %, and removing the unreacted polyisocyanate for purification. In this case, a mono- to hexavalent alcohol compound can be used in combination.

Examples of polyisocyanates having a biuret bond include a biuret modified product of 1,6-hexamethylene diisocyanate (HDI), a biuret modified product of isophorone diisocyanate (IPDI), and a biuret modified product of toluene diisocyanate (TDI) shown below. Commercial products include Desmodur N75, Desmodur N100, and Desmodur N3200 (all produced by Sumika Covestro Urethane Co., Ltd.); Duranate 24A-100, Duranate 22A-75P, and Duranate 21S-75E (all produced by Asahi Kasei Corporation); and the like.

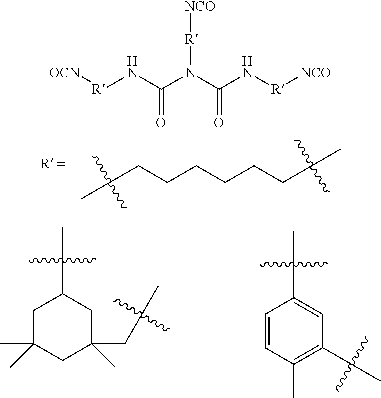

A polyisocyanate having an isocyanurate bond is obtained, for example, by performing the cyclic trimerization reaction using a catalyst etc., stopping the reaction when the conversion rate reaches about 5 to about 80 mass %, and removing the unreacted polyisocyanate for purification. In this case, a mono- to hexavalent alcohol compound can be used in combination.

The catalyst for the above isocyanuration reaction is generally preferably a basic catalyst. Examples of the catalyst include the following:
(1) hydroxides of tetraalkylammonium, such as tetramethylammonium, tetraethylammonium, and trimethylbenzylammonium; and organic weak acid salts, such as acetic acid and capric acid;
(2) hydroxides of hydroxyalkylammonium, such as trimethylhydroxypropylammonium, trimethylhydroxyethylammonium, triethylhydroxypropylammonium, and triethylhydroxyethylammonium; and organic weak acid salts, such as acetic acid and capric acid;
(3) alkyl metal salts of alkyl carboxylic acids with, for example, tin, zinc, and lead;
(4) metal alcoholates of sodium, potassium, etc.;
(5) aminosilyl group-containing compounds, such as hexamethyldisilazane;
(6) Mannich bases;
(7) combination of tertiary amines and epoxy compounds;
(8) phosphorus-based compounds, such as tributylphosphine.
   These can be used in combination of two or more.

If the catalyst for the isocyanuration reaction may affect cured products or cured physical properties, the catalyst may be neutralized with an acidic compound. Examples of acidic compounds include inorganic acids, such as hydrochloric acid, phosphorous acid, and phosphoric acid; sulfonic acids or derivatives thereof, such as methanesulfonic acid, p-toluenesulfonic acid, p-toluenesulfonic acid methyl ester, and p-toluenesulfonic acid ethyl ester; ethyl phosphate, diethyl phosphate, isopropyl phosphate, diisopropyl phosphate, butyl phosphate, dibutyl phosphate, 2-ethylhexyl phosphate, di(2-ethylhexyl)phosphate, isodecyl phosphate, diisodecyl phosphate, oleyl acid phosphate, tetracosyl acid phosphate, ethyl glycol acid phosphate, butyl pyrophosphate, butyl phosphite, and the like. These may be used in combination of two or more.

Examples of polyisocyanates having an isocyanurate bond include isocyanurate-modified HDI, isocyanurate-modified IPDI, and isocyanurate-modified TDI shown below. Commercial products include Sumidur N3300, Desmodur 3900, Desmodur Z4470BA, Desmodur XP2763, Desmodur IL1351BA, and Desmodur HLBA (all produced by Sumika Covestro Urethane Co., Ltd.); Duranate TPA-100, Duranate MFA-75B, Duranate TUL-100, and Duranate TSA-100 (all produced by Asahi Kasei Corporation); and the like.

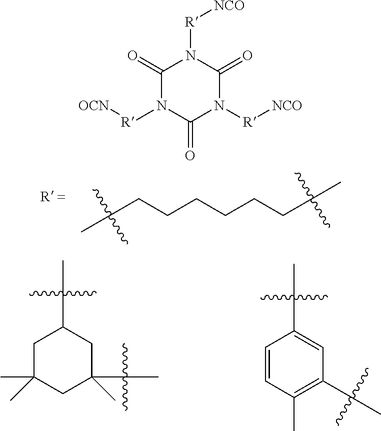

Specific examples of the isocyanate compound are shown below. However, the present invention is not limited thereto.

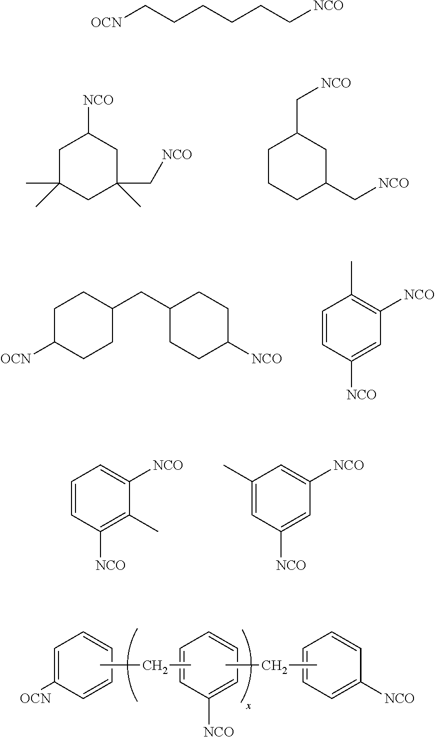

wherein x is an integer of 1 or more and 20 or less.

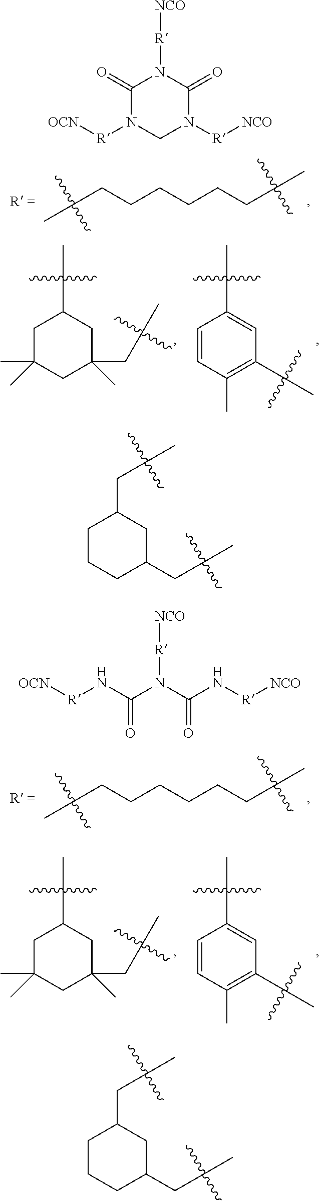

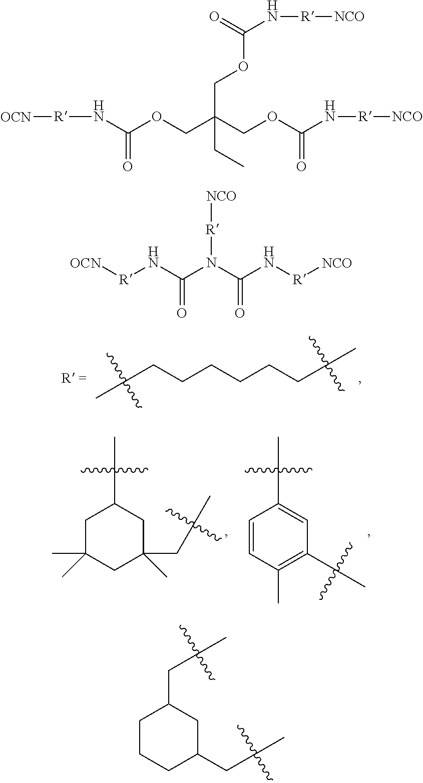

The blocking agent that blocks the isocyanate compound is preferably a nitrogen-containing compound represented by the following Formula (1) or Formula (2).

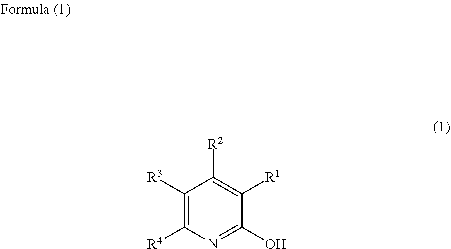

wherein R¹, R², R³, and R⁴ are the same or different, and each represents a C₁₋₂₀ hydrocarbon group optionally containing at least one member selected from the group consisting of a heteroatom and a halogen atom, a hydrogen atom, a halogen atom, or a —X¹R^{a}(R^{b})ₐ₁ group, wherein X¹ is an oxygen atom or a nitrogen atom, a1 is 0 or 1, when X¹ is an oxygen atom, a1 is 0, and when X¹ is a nitrogen atom, a1 is 1; R^{a} and R^{b} are the same or different, and each represents a C₁₋₂₀ hydrocarbon group optionally containing a heteroatom or a halogen atom; R¹ and R² and/or R² and R³ and/or R³ and R⁴ may form a ring structure together with the carbon atoms to which they are bonded; and the heteroatom is at least one member selected from the group consisting of a nitrogen atom, an oxygen atom, and a sulfur atom.

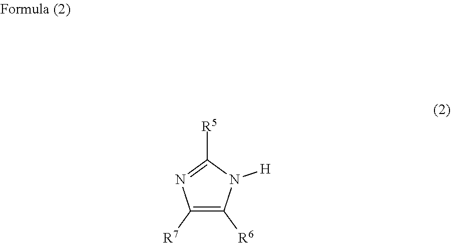

wherein R⁵, R⁶, and R⁷ are the same or different, and each represents a C₁₋₂₀ hydrocarbon group optionally containing at least one member selected from the group consisting of a heteroatom and a halogen atom, a hydrogen atom, a halogen atom, or a —X²R^{c} (R^{d})ₐ₂ group, wherein X² is an oxygen atom or a nitrogen atom, a2 is 0 or 1, when X² is an oxygen atom, a2 is 0, and when X² is a nitrogen atom, a2 is 1; R^{c} and R^{d} are the same or different, and each represents a C₁₋₂₀ hydrocarbon group optionally containing at least one member selected from the group consisting of a heteroatom and a halogen atom; R⁶ and R⁷ may form a ring structure together with the carbon atoms to which they are bonded; and the heteroatom is at least one member selected from the group consisting of a nitrogen atom, an oxygen atom, and a sulfur atom.

In R¹, R², R³, and R⁴, specific examples of the hydrocarbon group in the C₁₋₂₀ hydrocarbon group optionally containing at least one member selected from the group consisting of a heteroatom and a halogen atom include alkyl groups, such as methyl, ethyl, propyl, isobutyl, butyl, tert-butyl, pentyl, hexyl, heptyl, octyl, nonyl, decyl, dodecyl, octadecyl, and cyclohexyl groups; aryl groups, such as phenyl and naphthyl groups; and aralkyl groups, such as a benzyl group.

In R¹, R², R³, and R⁴, when the C₁₋₂₀ hydrocarbon group optionally containing at least one member selected from the group consisting of a heteroatom and a halogen atom contains a heteroatom, examples of the heteroatom include an oxygen atom, a nitrogen atom, and a sulfur atom, and the number of heteroatoms is preferably 1 to 5, more preferably 1 to 3, and even more preferably 1 or 2. The hydrocarbon group may contain one type of heteroatom, or two or three types of heteroatoms. When the hydrocarbon group contains at least one heteroatom, such as an oxygen atom, a nitrogen atom, or a sulfur atom, the hydrocarbon group has at least one group, such as —O—, —N<, —S—, or —SO₂—, and the hydrocarbon chain may be interrupted by such a group.

In R¹, R², R³, and R⁴, when the C₁₋₂₀ hydrocarbon group optionally having at least one member selected from the group consisting of a heteroatom and a halogen atom contains a halogen atom, examples of the halogen include a fluorine atom, a chlorine atom, a bromine atom, an iodine atom, and the like. The number of halogen atoms is preferably 1 to 5, more preferably 1 to 3, and even more preferably 1 or 2. The hydrocarbon group may contain one type of halogen atom, or two or three types of halogen atoms.

When R¹, R², R³, or R⁴ is a halogen atom, examples of the halogen atom include a fluorine atom, a chlorine atom, a bromine atom, an iodine atom, and the like.

When R¹, R², R³, or R⁴ in Formula (1) is a —X¹R^{a}(R^{b})ₐ₁ group, X¹ is an oxygen atom or a nitrogen atom. a1 is 0 or 1, when X¹ is an oxygen atom, a1 is 0, and when X¹ is a nitrogen atom, a1 is 1.

R^{a} and R^{b} are the same or different, and each represents a C₁₋₂₀ hydrocarbon group optionally containing at least one member selected from the group consisting of a heteroatom and a halogen atom, preferably a C₁₋₁₀ hydrocarbon group optionally containing at least one member selected from the group consisting of a heteroatom and a halogen atom, and more preferably a C₁₋₆ hydrocarbon group optionally containing at least one member selected from the group consisting of a heteroatom and a halogen atom. In this case, in a preferred embodiment, R^{a} and R^{b} are each a C₁₋₂₀ alkyl group optionally having at least one member selected from the group consisting of a heteroatom and a halogen atom, a C₆₋₂₀ aryl group optionally having at least one member selected from the group consisting of a heteroatom and a halogen atom, or a C₇₋₂₀ aralkyl group optionally having at least one member selected from the group consisting of a heteroatom and a halogen atom; preferably a C₁₋₁₀ alkyl group optionally having at least one member selected from the group consisting of a heteroatom and a halogen atom, a C₆₋₁₀ aryl group optionally having at least one member selected from the group consisting of a heteroatom and a halogen atom, or a C₇₋₁₀ aralkyl group optionally having at least one member selected from the group consisting of a heteroatom and a halogen atom; more preferably a C₁₋₆ alkyl group optionally having at least one member selected from the group consisting of a heteroatom and a halogen atom, or a C6 aryl group optionally having at least one member selected from the group consisting of a heteroatom and a halogen atom.

In R^{a} and R^{b}, examples of the “C₁₋₂₀ hydrocarbon group” include methyl, ethyl, propyl, isopropyl, butyl, sec-butyl, tert-butyl, pentyl, hexyl, heptyl, octyl, nonyl, decyl, dodecyl, octadecyl, cyclopropyl, cyclopentyl, cyclohexyl, phenyl, naphthyl, benzyl, phenethyl, tolyl, and allyl groups; preferably methyl, ethyl, propyl, isopropyl, butyl, sec-butyl, tert-butyl, pentyl, hexyl, heptyl, octyl, nonyl, decyl, benzyl, and phenyl groups; more preferably methyl, ethyl, propyl, isopropyl, butyl, sec-butyl, tert-butyl, benzyl, and phenyl groups; and even more preferably methyl, ethyl, and tert-butyl groups.

In R^{a} and R^{b}, examples of the “C₁₋₂₀ alkyl group” include methyl, ethyl, propyl, isopropyl, butyl, sec-butyl, tert-butyl, pentyl, hexyl, heptyl, octyl, and 2-ethylhexyl groups; and preferably methyl, ethyl, isopropyl, and tert-butyl groups.

In R^{a} and R^{b}, examples of the “C₆₋₂₀ aryl group” include phenyl, naphthyl, and tolyl groups; preferably phenyl and tolyl groups; and more preferably a phenyl group.

In R^{a} and R^{b}, examples of the “C₇₋₂₀ aralkyl group” include benzyl, p-methylbenzyl, p-octylbenzyl, p-decylbenzyl, p-dodecylbenzyl, p-tetradecylbenzyl, and p-phenylbenzyl groups; and preferably benzyl and p-methylbenzyl groups.

In R^{a} and R^{b}, when the C₁₋₂₀ hydrocarbon group optionally containing at least one member selected from the group consisting of a heteroatom and a halogen atom contains a heteroatom, examples of the heteroatom include an oxygen atom, a nitrogen atom, and a sulfur atom, and the number of heteroatoms is preferably 1 to 5, more preferably 1 to 3, and even more preferably 1 or 2. The hydrocarbon group may contain one type of heteroatom, or two or three types of heteroatoms. When the hydrocarbon group contains at least one heteroatom, such as an oxygen atom, a nitrogen atom, or a sulfur atom, the hydrocarbon group has at least one group, such as —O—, —N<, —S—, or —SO₂—, and the hydrocarbon chain may be interrupted by such a group.

In R^{a} and R^{b}, when the C₁₋₂₀ hydrocarbon group optionally containing at least one member selected from the group consisting of a heteroatom and a halogen atom contains a halogen atom, examples of the halogen include a fluorine atom, a chlorine atom, a bromine atom, an iodine atom, and the like. The number of halogen atoms is preferably 1 to 5, more preferably 1 to 3, and even more preferably 1 or 2. The hydrocarbon group may contain one type of halogen atom, or two or three types of halogen atoms.

R¹ and R² and/or R² and R³ and/or R³ and R⁴ may form a ring structure together with the carbon atoms to which they are bonded. When a ring structure is formed, they may have, in the ring structure, at least one heteroatom, such as an oxygen atom, a nitrogen atom, or a sulfur atom. When the ring structure is substituted with at least one heteroatom, such as an oxygen atom, a nitrogen atom, or a sulfur atom, they can have at least one group, such as —O—, —N<, —N═, —S—, - or SO₂—.

Examples of such a ring structure include structures such as optionally substituted benzene, optionally substituted cyclopentadiene, optionally substituted cyclohexane, optionally substituted pyrrole, optionally substituted thiophene, optionally substituted furan, optionally substituted imidazole, optionally substituted oxazole, optionally substituted thiazole, optionally substituted thiophene dioxide, and optionally substituted pyridine. These have a fused structure with the pyridine ring in Formula (1).

When such a ring structure is substituted, the number of substituents can be 1 to 5, preferably 1 to 3, and more preferably 1 or 2.

Examples of substituents include halogen atoms, such as fluorine, chlorine, bromine, and iodine; dialkylamino groups, such as dimethylamino; alkoxy groups, such as methoxy and ethoxy; aryloxy groups, such as phenoxy and naphthyloxy; aralkyloxy groups, such as benzyloxy and naphthylmethoxy; halogenated alkyl groups, such as alkylcarbonyl(alkyl)amino and trifluoromethyl groups; nitro groups, cyano groups, sulfonyl groups, and the like.

Examples of the alkyl moiety of the above dialkylamino groups, halogenated alkyl groups, alkoxy groups, alkylcarbonyl(alkyl)amino groups, and halogenated alkyl groups include linear or branched C₁₋₁₂ alkyl groups, such as methyl, ethyl, propyl, isopropyl, n-butyl, isobutyl, sec-butyl, tert-butyl, pentyl, 1-ethylpentyl, heptyl, octyl, and 2-ethylhexyl. The number of carbon atoms in the alkyl group is preferably 1 to 8, and more preferably 1 or 2.

Examples of the aryl moiety of the above aryloxy groups include C₆₋₁₀ aryl groups. Specific examples of the aryl moiety include a phenyl group, a naphthyl group, and the like. Examples of the aralkyl moiety of the above aralkyloxy groups include C₇₋₁₄ aralkyl groups. Specific examples of the aralkyl moiety include a benzyl group, a naphthylmethyl group, and the like.

Specific examples of the nitrogen-containing compound of Formula (1) include 2-hydroxypyridine, 3-methyl-2-hydroxypyridine, 4-methyl-2-hydroxypyridine, 5-methyl-2-hydroxypyridine, 6-methyl-2-hydroxypyridine, 3-chloro-2-hydroxypyridine, 4-chloro-2-hydroxypyridine, 5-chloro-2-hydroxypyridine, 6-chloro-2-hydroxypyridine, and 2-quinolinol; and preferably 2-hydroxypyridine, 5-methyl-2-hydroxypyridine, and 5-chloro-2-hydroxypyridine.

In R⁵, R⁶, and R⁷ of Formula (2), specific examples of the hydrocarbon group in the C₁₋₂₀ hydrocarbon group optionally containing at least one member selected from the group consisting of a heteroatom and a halogen atom include C₁₋₂₀ alkyl groups, such as methyl, ethyl, propyl, isobutyl, butyl, tert-butyl, pentyl, hexyl, heptyl, octyl, nonyl, decyl, dodecyl, octadecyl, and cyclohexyl groups; C₆₋₂₀ aryl groups, such as phenyl and naphthyl groups; and C₇₋₂₀ aralkyl groups, such as a benzyl group.

When the C₁₋₂₀ hydrocarbon group optionally containing at least one member selected from the group consisting of a heteroatom and a halogen atom represented by R⁵, R⁶, or R⁷ contains a heteroatom, examples of the heteroatom include an oxygen atom, a nitrogen atom, and a sulfur atom, and the number of heteroatoms is preferably 1 to 5, more preferably 1 to 3, and even more preferably 1 or 2. The hydrocarbon group may contain one type of heteroatom, or two or three types of heteroatoms. When the hydrocarbon group contains at least one heteroatom, such as an oxygen atom, a nitrogen atom, or a sulfur atom, the hydrocarbon group has at least one group, such as —O—, —N<, —S—, or —SO₂—, and the hydrocarbon chain may be interrupted by such a group.

When the C₁₋₂₀ hydrocarbon group optionally having at least one member selected from the group consisting of a heteroatom and a halogen atom represented by R⁵, R⁶, or R⁷ contains a halogen atom, examples of the halogen include a fluorine atom, a chlorine atom, a bromine atom, an iodine atom, and the like. The number of halogen atoms is preferably 1 to 5, more preferably 1 to 3, and even more preferably 1 or 2. The hydrocarbon group may contain one type of halogen atom, or two or three types of halogen atoms.

When R⁵, R⁶, or R⁷ is a halogen atom, examples of the halogen atom include a fluorine atom, a chlorine atom, a bromine atom, an iodine atom, and the like.

In Formula (2), when R⁵, R⁶, or R⁷ is a —X²R^{c}(R^{d})ₐ₂ group, X² is an oxygen atom or a nitrogen atom. a2 is 0 or 1, when X² is an oxygen atom, a2 is 0, and when X² is a nitrogen atom, a2 is 1. R^{c} and R^{d} are the same or different, and each represents a C₁₋₂₀ hydrocarbon group optionally containing at least one member selected from the group consisting of a heteroatom and a halogen atom; preferably a C₁₋₁₀ hydrocarbon group optionally containing at least one member selected from the group consisting of a heteroatom and a halogen atom; and more preferably a C₁₋₆ hydrocarbon group optionally containing at least one member selected from the group consisting of a heteroatom and a halogen atom.

In this case, in a preferred embodiment, R^{c} and R^{d} are each a C₁₋₂₀ alkyl group optionally having at least one member selected from the group consisting of a heteroatom and a halogen atom, a C₆₋₂₀ aryl group optionally having at least one member selected from the group consisting of a heteroatom and a halogen atom, or a C₇₋₂₀ aralkyl group optionally having at least one member selected from the group consisting of a heteroatom and a halogen atom; preferably a C₁₋₁₀ alkyl group optionally having at least one member selected from the group consisting of a heteroatom and a halogen atom, a C₆₋₁₀ aryl group optionally having at least one member selected from the group consisting of a heteroatom and a halogen atom, or a C₇₋₁₀ aralkyl group optionally having at least one member selected from the group consisting of a heteroatom and a halogen atom; and more preferably a C₁₋₆ alkyl group optionally having at least one member selected from the group consisting of a heteroatom and a halogen atom, or a C₆ aryl group optionally having at least one member selected from the group consisting of a heteroatom and a halogen atom.

In R^{c} and R^{d}, examples of the “C₁₋₂₀ hydrocarbon group” include methyl, ethyl, propyl, isopropyl, butyl, sec-butyl, tert-butyl, pentyl, hexyl, heptyl, octyl, nonyl, decyl, dodecyl, octadecyl, cyclopropyl, cyclopentyl, cyclohexyl, phenyl, naphthyl, benzyl, phenethyl, tolyl, and allyl groups; preferably methyl, ethyl, propyl, isopropyl, butyl, sec-butyl, tert-butyl, pentyl, hexyl, heptyl, octyl, nonyl, decyl, benzyl, and phenyl groups; more preferably methyl, ethyl, propyl, isopropyl, butyl, sec-butyl, tert-butyl, benzyl, and phenyl groups; and even more preferably methyl, ethyl, and tert-butyl groups.

In R^{c} and R^{d}, examples of the “C₁₋₂₀ alkyl group” include methyl, ethyl, propyl, isopropyl, butyl, sec-butyl, tert-butyl, pentyl, hexyl, heptyl, octyl, and 2-ethylhexyl groups; and preferably methyl, ethyl, isopropyl, and tert-butyl groups.

In R^{c} and R^{d}, examples of the “C₆₋₂₀ aryl group” include phenyl, naphthyl, and tolyl groups; preferably phenyl and tolyl groups; and more preferably a phenyl group.

In R^{c} and R^{d}, examples of the “C₇₋₂₀ aralkyl group” include benzyl, p-methylbenzyl, p-octylbenzyl, p-decylbenzyl, p-dodecylbenzyl, p-tetradecylbenzyl, and p-phenylbenzyl groups; and preferably benzyl and p-methylbenzyl groups.

In R^{c} and R^{d}, when the C₁₋₂₀ hydrocarbon group optionally containing at least one member selected from the group consisting of a heteroatom and a halogen atom contains a heteroatom, examples of the heteroatom include an oxygen atom, a nitrogen atom, and a sulfur atom, and the number of heteroatoms is preferably 1 to 5, more preferably 1 to 3, and even more preferably 1 or 2. The hydrocarbon group may contain one type of heteroatom, or two or three types of heteroatoms. When the hydrocarbon group contains at least one heteroatom, such as an oxygen atom, a nitrogen atom, or a sulfur atom, the hydrocarbon group has at least one group, such as —O—, —N<, —S—, or —SO₂—, and the hydrocarbon chain may be interrupted by such a group.

In R^{c} and R^{d}, when the C₁₋₂₀ hydrocarbon group optionally containing a heteroatom or a halogen atom contains a halogen atom, examples of the halogen include a fluorine atom, a chlorine atom, a bromine atom, an iodine atom, and the like. The number of halogen atoms is preferably 1 to 5, more preferably 1 to 3, and even more preferably 1 or 2. The hydrocarbon group may contain one type of halogen atom, or two or three types of halogen atoms.

R⁶ and R⁷ may form a ring structure together with the carbon atoms to which they are bonded. When a ring structure is formed, they may have, in the ring structure, at least one heteroatom, such as an oxygen atom, a nitrogen atom, or a sulfur atom. When the ring structure is substituted with at least one heteroatom, such as an oxygen atom, a nitrogen atom, or a sulfur atom, they can have at least one group, such as —O—, —N<, —N═, —S—, - or SO₂—.

Examples of such a ring structure include structures such as optionally substituted benzene, optionally substituted cyclopentadiene, optionally substituted cyclohexane, optionally substituted pyrrole, optionally substituted thiophene, optionally substituted furan, optionally substituted imidazole, optionally substituted oxazole, optionally substituted thiazole, optionally substituted thiophene dioxide, and optionally substituted pyridine. These have a fused structure with the imidazole ring in Formula (2).

When such a ring structure is substituted, the number of substituents can be 1 to 5, preferably 1 to 3, and more preferably 1 or 2.

Examples of substituents include halogen atoms, such as fluorine, chlorine, bromine, and iodine; dialkylamino groups, such as dimethylamino; alkoxy groups, such as methoxy and ethoxy; aryloxy groups, such as phenoxy and naphthyloxy; aralkyloxy groups, such as benzyloxy and naphthylmethoxy; halogenated alkyl groups, such as alkylcarbonyl(alkyl)amino and trifluoromethyl groups; nitro groups, cyano groups, sulfonyl groups, and the like.

Examples of the alkyl moiety of the above dialkylamino groups, halogenated alkyl groups, alkoxy groups, alkylcarbonyl(alkyl)amino groups, and halogenated alkyl groups include linear or branched C₁₋₁₂ alkyl groups, such as methyl, ethyl, propyl, isopropyl, n-butyl, isobutyl, sec-butyl, tert-butyl, pentyl, 1-ethylpentyl, heptyl, octyl, and 2-ethylhexyl. The number of carbon atoms in the alkyl group is preferably 1 to 8, and more preferably 1 or 2.

Examples of the aryl moiety of the above aryloxy groups include C₆₋₁₀ aryl groups. Specific examples of the aryl moiety include a phenyl group, a naphthyl group, and the like. Examples of the aralkyl moiety of the above aralkyloxy groups include C₇₋₁₄ aralkyl groups. Specific examples of the aralkyl moiety include a benzyl group, a naphthylmethyl group, and the like.

Specific examples of the nitrogen-containing compound represented by Formula (2) include imidazole, 2-methylimidazole, 4-methylimidazole, 4,5-dimethylimidazole, 2-ethylimidazole, 2-isopropylimidazole, 2-heptylimidazole, and 2-phenylimidazole; and preferably imidazole, 2-methylimidazole, 2-heptylimidazole, and 2-phenylimidazole.

The blocked isocyanate compound in which an isocyanate group of an isocyanate compound is blocked with a nitrogen-containing compound represented by Formula (1) or Formula (2) may be a commercial product or may be produced by a known method. Further, the blocked isocyanate compound can be produced, for example, by a production method described below.

The blocked isocyanate compound can be produced by reacting an isocyanate compound and the nitrogen-containing compound of Formula (1) or Formula (2), if necessary, in the presence of a urethanization catalyst and a solvent.

The amount of the nitrogen-containing compound represented by Formula (1) or Formula (2) used in the production of the blocked isocyanate compound is generally 0.8 to 10 mol, and preferably 0.8 to 1.2 mol, per mol of isocyanate groups in the isocyanate compound.

A urethanization catalyst may or may not be used. When a urethanization catalyst is used, specific examples include tertiary amine catalysts, such as triethylamine, diisopropylethylamine, 1,4-diazabicyclo[2.2.2]octane, 1,8-diazabicyclo[5.4.0]undecene-7, N-methylmorpholine, N-ethylmorpholine, and 1-methylimidazole; carboxylic acid metal salts, such as potassium acetate, potassium octylate, stannous octylate, dibutyl stannic dilaurate, and zinc octylate; and preferably triethylamine.

A solvent may or may not be used. When a solvent is used, specific examples include aromatic hydrocarbons, such as toluene, benzene, and xylene; aliphatic or alicyclic hydrocarbons, such as methylcyclohexane, cyclohexane, hexane, heptane, and octane; halogenated hydrocarbons, such as dichloromethane, chloroform, carbon tetrachloride, and 1,2-dichloroethane; halogenated aromatic hydrocarbons, such as chlorobenzene and dichlorobenzene; ethers, such as diethyl ether, tetrahydrofuran, and 1,4-dioxane; ketones, such as methyl isobutyl ketone; esters, such as butyl acetate; and the like. Preferred among these are aromatic hydrocarbons, ketones, and esters; and particularly preferred are methyl isobutyl ketone, butyl acetate, and ethyl acetate. The solvents can be used as a mixture of two or more, if necessary.

The amount of solvent used is generally 50 parts by mass or less, and preferably 0.1 to 10 parts by mass, per part by mass of the isocyanate compound.

The reaction temperature is generally −10° C. or higher, preferably 0° C. to 150° C., and more preferably 30° C. to 100° C.

The reaction may be performed, if necessary, in an inert gas atmosphere, such as nitrogen, argon, or helium, which do not affect the reaction.

After completion of the reaction, the blocked isocyanate compound can be obtained by removing the solvent and the unreacted nitrogen-containing compound represented by Formula (1) or Formula (2) by concentrating or filtering the reaction liquid, and may be purified by recrystallization, column separation, etc., if necessary.

### Curable Composition

The curable composition of the present invention comprises one or more metal complex compounds comprising at least one metal from Groups 4 to 13, and a blocked isocyanate compound in which an isocyanate group of an isocyanate compound is blocked with a nitrogen-containing compound represented by Formula (1) or Formula (2). The curable composition of the present invention may further comprise a compound having an isocyanate-reactive group.

In the present invention, the metal complex compound comprising at least one metal from Groups 4 to 13 in the curable composition is considered to promote the following reactions:
1) a ureation reaction of an isocyanate with water or moisture, and
2) a urethanization reaction of an isocyanate with a polyol, which is a compound having an isocyanate-reactive group.

Of these, the metal complex compound is excellent in promoting 1) a ureation reaction of an isocyanate with water or moisture.

The cause for this is considered as follows. During curing of the blocked isocyanate compound of the present invention, the nitrogen-containing compound represented by Formula (1) is dissociated, and the effect of poisoning by the dissociated nitrogen-containing compound represented by Formula (1) on the curing catalyst for a blocked isocyanate compound of the present invention is small.

Further, the dissociated nitrogen-containing compound represented by Formula (1) acts as an acid against an amine catalyst, such as bis(2-dimethylaminoethyl)ether, to form a salt, which is considered to lead to the reduction in the activity of the amine catalyst. On the other hand, since the curing catalyst for a blocked isocyanate compound of the present invention does not form a salt with the dissociated nitrogen-containing compound represented by Formula (1), it is considered that the catalyst activity is not reduced.

From the above, the curing catalyst for a blocked isocyanate compound of the present invention can be suitably used particularly for curing a blocked isocyanate compound blocked with the nitrogen-containing compound represented by Formula (1).

In the curable composition of the present invention, known catalysts for polyurethane production, additives, pigments, solvents, and the like that are commonly used in this technical field can be used, if necessary.

Known catalysts for polyurethane production are not particularly limited. Examples include tin compounds, such as dibutyltin dilaurate (DBTDL), dibutyltin di-2-ethylhexanate, dioctyltin dilaurate, dibutyltin diacetate, dibutyltin dioxide, dioctyltin dioxide, tin acetylacetonate, tin acetate, tin octylate, and tin laurate; bismuth compounds, such as bismuth octylate, bismuth naphthenate, and bismuth acetylacetonate; tertiary amine compounds, such as triethylamine, N,N,N′,N′-tetramethylethylenediamine, N,N,N′,N′-tetramethylpropylenediamine, N,N,N′,N″,N″-pentamethyldiethylenetriamine, N,N,N′,N″,N″-pentamethyldipropylenetriamine, N,N,N′,N′-tetramethylguanidine, 1,3,5-tris(N,N-dimethylaminopropyl)hexahydro-S-triazine, 1,4-diazabicyclo[2.2.2]octane (DABCO), 1,8-diazabicyclo[5.4.0]undecene-7, triethylenediamine, N,N,N′,N′-tetramethylhexamethylenediamine, N-methyl-N′-(2-dimethylaminoethyl) piperazine, N,N′-dimethylpiperazine, dimethylcyclohexylamine, N-methylmorpholine, N-ethylmorpholine, bis(2-dimethylaminoethyl)ether, 1-methylimidazole, 1,2-dimethylimidazole, 1-isobutyl-2-methylimidazole, and 1-dimethylaminopropylimidazole; and quaternary ammonium salt compounds, such as tetraalkylammonium halides (e.g., tetramethylammonium chloride), tetraalkylammonium hydroxides (e.g., tetramethylammonium hydroxide salts), tetraalkylammonium organic acid salts (e.g., tetramethylammonium-2-ethylhexanoate, 2-hydroxypropyl trimethylammonium formate, and 2-hydroxypropyl trimethylammonium-2-ethylhexanoate).

Additives are not particularly limited. Examples include hindered amine-based, benzotriazole-based, and benzophenone-based UV absorbers; perchlorate-based and hydroxylamine-based coloration inhibitors; hindered phenol-based, phosphorus-based, sulfur-based, and hydrazide-based antioxidants; leveling agents, rheology control agents, pigment dispersants, and the like.

Pigments are not particularly limited. Examples include organic pigments, such as quinacridone-based, azo-based, and phthalocyanine-based pigments; inorganic pigments, such as titanium oxide, barium sulfate, calcium carbonate, and silica; and other pigments, such as carbon-based pigments, metal foil pigments, and rust-preventive pigments.

Solvents are not particularly limited. Examples include hydrocarbons, such as benzene, toluene, xylene, cyclohexane, mineral spirit, and naphtha; ketones, such as acetone, methyl ethyl ketone, and methyl isobutyl ketone; esters, such as ethyl acetate, butyl acetate, and cellosolve acetate; alcohols, such as methanol, ethanol, 2-propanol, butanol, 2-methoxyethanol, 2-ethoxyethanol, and 2-butoxyethanol; polyhydric alcohols, such as ethylene glycol, propylene glycol, diethylene glycol, polyethylene glycol, and glycerol; and the like. These solvents may be used singly or in combination of two or more.

The curable composition of the present invention preferably contains 0.1 to 10 mass %, and more preferably 0.5 to 5 mass %, of one or more metal complex compounds comprising at least one metal from Groups 4 to 13 based on the blocked isocyanate compound.

Examples of the compound having an isocyanate-reactive group include compounds having two or more active hydrogen groups, such as polyols, polyamines, and alkanolamines; and preferably polyols. These compounds having an isocyanate-reactive group may be a mixture of two or more.

In the present invention, polyols are compounds having two or more hydroxyl groups. Examples include polyester polyols, polyether polyols, acrylic polyols, polyolefin polyols, fluorine polyols, and the like. Preferred polyols among these are acrylic polyols in terms of weather resistance, chemical resistance, and hardness. Alternatively, polyols preferred in terms of mechanical strength and oil resistance are polyester polyols. These polyols may be a mixture of two or more.

Examples of polyether polyols include active hydrogen compounds, such as aliphatic amine polyols, aromatic amine polyols, Mannich polyols, polyhydric alcohols, polyhydric phenols, and bisphenols; compounds obtained by adding alkylene oxides to these active hydrogen compounds; and the like. These polyether polyols may be a mixture of two or more. Examples of aliphatic amine polyols include alkylenediamine-based polyols and alkanolamine-based polyols. These polyol compounds are polyfunctional polyol compounds having terminal hydroxyl groups obtained by the ring-opening addition of at least one cyclic ether, such as ethylene oxide or propylene oxide, using alkylenediamine or alkanolamine as an initiator. As the alkylenediamine, known compounds can be used without limitation. Specifically, C₂₋₈ alkylenediamines, such as ethylenediamine, propylenediamine, butylenediamine, hexamethylenediamine, and neopentyldiamine, are preferably used. These aliphatic amine polyols may be a mixture of two or more.

Aromatic amine polyols are polyfunctional polyether polyol compounds having terminal hydroxyl groups obtained by the ring-opening addition of at least one cyclic ether, such as ethylene oxide or propylene oxide, using an aromatic diamine as an initiator. As the initiator, a known aromatic diamine can be used without limitation. Specific examples include 2,4-toluenediamine, 2,6-toluenediamine, diethyltoluenediamine, 4,4′-diaminodiphenylmethane, p-phenylenediamine, o-phenylenediamine, naphthalenediamine, and the like. Among these, toluenediamine (2,4-toluenediamine, 2,6-toluenediamine, or a mixture thereof) is particularly preferably used. These aromatic amine polyols may be a mixture of two or more.

Mannich polyols are active hydrogen compounds obtained by the Mannich reaction of phenol and/or an alkyl-substituted derivative thereof, formaldehyde, and alkanolamine, or polyol compounds obtained by the ring-opening addition polymerization of the active hydrogen compounds with at least one of ethylene oxide and propylene oxide. These Mannich polyols may be a mixture of two or more.

Examples of polyhydric alcohols include dihydric alcohols (e.g., ethylene glycol, propylene glycol, 1,4-butanediol, 1,6-hexanediol, diethylene glycol, triethylene glycol, dipropylene glycol, and neopentyl glycol), trihydric or higher alcohols (e.g., glycerol, trimethylolpropane, pentaerythritol, methylglucoside, sorbitol, and sucrose), and the like. These polyhydric alcohols may be a mixture of two or more.

Examples of polyhydric phenols include pyrogallol, hydroquinone, and the like. These polyhydric phenols may be a mixture of two or more.

Examples of bisphenols include bisphenol A, bisphenol S, bisphenol F, low-condensates of phenols and formaldehyde, and the like. These bisphenols may be a mixture of two or more.

Polyester polyols can be obtained, for example, by the condensation reaction of a single dibasic acid or a mixture of two or more dibasic acids with a single polyhydric alcohol or a mixture of two or more polyhydric alcohols.

Examples of dibasic acids include carboxylic acids, such as succinic acid, adipic acid, dimer acid, maleic anhydride, phthalic anhydride, isophthalic acid, terephthalic acid, and 1,4-cyclohexanedicarboxylic acid; and the like. Examples of polyhydric alcohols include ethylene glycol, propylene glycol, diethylene glycol, 1,4-butanediol, neopentyl glycol, 1,6-hexanediol, trimethylpentanediol, cyclohexanediol, trimethylolpropane, glycerol, pentaerythritol, 2-methylolpropanediol, ethoxylated trimethylolpropane, and the like.

As a specific method for producing polyester polyols, for example, the condensation reaction can be carried out by mixing the above components, and heating the mixture at about 160 to 220° C. Alternatively, for example, polycaprolactones obtained by the ring-opening polymerization of lactones, such as ε-caprolactone, with polyhydric alcohols can also be used as polyester polyols.

These polyester polyols can be modified by using, for example, aromatic diisocyanates, aliphatic diisocyanates, alicyclic diisocyanates, and isocyanates obtained from them. Among these, in terms of weather resistance, yellowing resistance, etc., polyester polyols are preferably modified by using aliphatic diisocyanates, alicyclic diisocyanates, and isocyanates obtained from them.

Polyether polyols can be obtained, for example, by any of the following methods (1) to (3).

(1) A method of performing random or block addition of an alkylene oxide alone or a mixture of alkylene oxides to a polyhydroxy compound alone or a mixture of polyhydroxy compounds using a catalyst to obtain polyether polyols.

Examples of catalysts include hydroxides (lithium hydroxide, sodium hydroxide, potassium hydroxide, etc.), strong base catalysts (alcoholates, alkylamines, etc.), composite metal cyanide compound complexes (metal porphyrins, zinc hexacyanocobaltate complexes, etc.), and the like.

Examples of alkylene oxides include ethylene oxide, propylene oxide, butylene oxide, cyclohexene oxide, styrene oxide, and the like.
(2) A method of reacting polyamine compounds with alkylene oxides to obtain polyethers polyols.

Examples of polyamine compounds include ethylene diamines and the like.

Examples of alkylene oxides include those mentioned in (1).

(3) A method of polymerizing acrylamide etc. using the polyether polyols obtained in (1) or (2) as media to obtain so-called polymer polyols.

Examples of polyhydroxy compounds include the following (i) to (vi).
(i) diglycerin, ditrimethylolpropane, pentaerythritol, dipentaerythritol, etc.
(ii) sugar alcohol compounds, such as erythritol, D-threitol, L-arabinitol, ribitol, xylitol, sorbitol, mannitol, galactitol, and rhamnitol
(iii) monosaccharides, such as arabinose, ribose, xylose, glucose, mannose, galactose, fructose, sorbose, rhamnose, fucose, and ribodesose
(iv) disaccharides, such as trehalose, sucrose, maltose, cellobiose, gentiobiose, lactose, and melibiose
(v) trisaccharides, such as raffinose, gentianose, and melezitose
(vi) tetrasaccharides, such as stachyose

Acrylic polyols can be obtained, for example, by polymerizing polymerizable monomers having one or more active hydrogens per molecule, or by copolymerizing polymerizable monomers having one or more active hydrogens per molecule with other monomers copolymerizable with the polymerizable monomers, if necessary.

Examples of polymerizable monomers having one or more active hydrogens per molecule include the following (i) to (vi). These may be used singly or in combination of two or more.
(i) acrylic acid esters having active hydrogen, such as 2-hydroxyethyl acrylate, 2-hydroxypropyl acrylate, and 2-hydroxybutyl acrylate
(ii) methacrylic acid esters having active hydrogen, such as 2-hydroxyethyl methacrylate, 2-hydroxypropyl methacrylate, 2-hydroxybutyl methacrylate, 3-hydroxypropyl methacrylate, and 4-hydroxybutyl methacrylate
(iii) (meth)acrylic acid esters having polyvalent active hydrogen, such as (meth)acrylic acid monoesters of triols, such as glycerol and trimethylolpropane
(iv) monoethers of polyether polyols (e.g., polyethylene glycol, polypropylene glycol, and polybutylene glycol) with the above (meth)acrylic acid esters having active hydrogen
(v) adducts of glycidyl (meth)acrylate with monobasic acids (e.g., acetic acid, propionic acid, and p-tert-butyl benzoic acid)
(vi) adducts obtained by the ring-opening polymerization of lactones (e.g., ε-caprolactam and γ-valerolactone) with the active hydrogen of the above (meta)acrylic acid esters having active hydrogen

Examples of monomers copolymerizable with the above polymerizable monomers include the following (i) to (iv). These may be used singly or in combination of two or more.
(i) (meth)acrylic acid esters, such as methyl acrylate, ethyl acrylate, isopropyl acrylate, n-butyl acrylate, 2-ethylhexyl acrylate, methyl methacrylate, ethyl methacrylate, isopropyl methacrylate, n-butyl methacrylate, isobutyl methacrylate, n-hexyl methacrylate, cyclohexyl methacrylate, lauryl methacrylate, and glycidyl methacrylate
(ii) unsaturated carboxylic acids, such as acrylic acid, methacrylic acid, maleic acid, and itaconic acid; and unsaturated amides, such as acrylamide, N-methylolacrylamide, and diacetoneacrylamide
(iii) vinyl monomers having a hydrolyzable silyl group, such as vinyl trimethoxysilane, vinyl methyl dimethoxysilane, and γ-(meth)acrylopropyltrimethoxysilane
(iv) other polymerizable monomers, such as styrene, vinyl toluene, vinyl acetate, acrylonitrile, and dibutyl fumarate

As a specific method for producing acrylic polyols, for example, the above monomer components are subjected to solution polymerization in the presence of a known radical polymerization initiator, such as a peroxide or an azo compound, optionally followed by dilution with an organic solvent etc., thereby obtaining acrylic polyols.

Examples of polyolefin polyols include polybutadiene having two or more hydroxyl groups, hydrogenated polybutadiene having two or more hydroxyl groups, hydrogenated polyisoprene having two or more hydroxyl groups, and the like. In the polyolefin polyol, the number of hydroxyl groups is preferably three because higher coating film strength can be obtained. In the present specification, “fluorine polyols” refer to polyols containing fluorine in the molecule. Specific examples of fluorine polyols include the copolymers of fluoroolefin, cyclovinyl ether, hydroxyalkyl vinyl ether, and vinyl monocarboxylate disclosed in JPS57-34107A, JPS61-275311A, etc. These documents are incorporated herein by reference in their entirety.

The lower limit of the hydroxyl value of the polyol is preferably 10 mgKOH/g or more, more preferably 20 mgKOH/g or more, and even more preferably 30 mgKOH/g or more. On the other hand, the upper limit of the hydroxyl value of the polyol is not particularly limited, and may be, for example, 200 mgKOH/g or less. Specifically, the hydroxyl value of the polyol is preferably 10 mgKOH/g or more and 200 mgKOH/g or less, more preferably 20 mgKOH/g or more and 200 mgKOH/g or less, and even more preferably 30 mgKOH/g or more and 200 mgKOH/g or less.

Further, the acid value of the polyol is preferably 0 mgKOH/g or more and 30 mgKOH/g or less. The hydroxyl value and acid value can be measured according to JIS K1557.

The molar equivalent ratio (NCO/OH) of isocyanate groups in the blocked isocyanate composition to hydroxyl groups in the polyol is preferably 0.2 or more and 5.0 or less, more preferably 0.4 or more and 3.0 or less, and even more preferably 0.5 or more and 2.0 or less. Usable polyamines are those having two or more primary amino groups or secondary amino groups per molecule. Preferred among these are those having three or more such amino groups per molecule.

Specific examples of polyamines include diamines, such as ethylenediamine, propylenediamine, butylenediamine, triethylenediamine, hexamethylenediamine, 4,4′-diaminodicyclohexylmethane, piperazine, 2-methylpiperazine, and isophoronediamine; chain polyamines having three or more amino groups, such as bishexamethylenetriamine, diethylenetriamine, triethylenetetramine, tetraethylenepentamine, pentamethylenehexamine, and tetrapropylenepentamine; and cyclic polyamines, such as 1,4,7,10,13,16-hexaazacyclooctadecane, 1,4,7,10-tetraazacyclodecane, 1,4,8,12-tetraazacyclopentadecane, and 1,4,8,11-tetraazacyclotetradecane.

Alkanolamines refer to compounds having an amino group and a hydroxyl group per molecule. Examples of alkanolamines include monoethanolamine, diethanolamine, aminoethylethanolamine, N-(2-hydroxypropyl)ethylenediamine, mono-, di-(n- or iso-)propanolamine, ethylene glycol-bis-propylamine, neopentanolamine, methylethanolamine, and the like.

The curable composition of the present embodiment may contain, if necessary, melamine-based curing agents, such as complete alkyl type, methylol type, and alkylamino group type alkyl.

The curable composition of the present embodiment may contain an organic solvent.

Further, the compound having an isocyanate-reactive group and the blocked isocyanate composition described above may contain an organic solvent. Preferable organic solvents are those that are compatible with the blocked isocyanate composition.

Specific examples of organic solvents include hydrocarbons, such as benzene, toluene, xylene, cyclohexane, mineral spirit, and naphtha; ketones, such as acetone, methyl ethyl ketone, and methyl isobutyl ketone; esters, such as ethyl acetate, butyl acetate, and cellosolve acetate; alcohols, such as methanol, ethanol, 2-propanol, butanol, 2-methoxyethanol, 2-ethoxyethanol, and 2-butoxyethanol; polyhydric alcohols, such as ethylene glycol, propylene glycol, diethylene glycol, polyethylene glycol, and glycerol; and the like. These solvents may be used singly or in combination of two or more.

Preferred among the above solvents are diethylene glycol dimethyl ether, diethylene glycol diethyl ether, propylene glycol monomethyl ether, propylene glycol dimethyl ether, dipropylene glycol dimethyl ether, isobutanol, butyl glycol, N-methylpyrrolidone, and butyl diglycol; and more preferred are diethylene glycol dimethyl ether, diethylene glycol diethyl ether, propylene glycol dimethyl ether, and dipropylene glycol dimethyl ether. These solvents may be used singly or in combination of two or more.

In the curable composition of the present invention, when a compound having an isocyanate-reactive group is mixed, the mixing ratio of the blocked isocyanate compound and the compound having an isocyanate-reactive group is determined by the required physical properties, and is not particularly limited. The mixing ratio is generally within the following range: [the amount of effective isocyanate groups (mol) in the blocked isocyanate compound in the curable composition]:[the amount of active hydrogen groups (mol) in the compound having an isocyanate-reactive group]=100:1 to 100:500, and preferably 100:1 to 100:100.

In another embodiment, in terms of the storage stability of the curable composition, the amount of the compound having an isocyanate-reactive group mixed is preferably such that the amount of active hydrogen groups in the compound having an isocyanate-reactive group is 70 mol or less based on the amount of effective isocyanate groups in the blocked isocyanate compound in the curable composition, which is taken as 100 mol. When a compound having an isocyanate-reactive group is mixed, the mixing ratio is preferably within the following range: [the amount of effective isocyanate groups (mol) in the blocked isocyanate compound in the curable composition]:[the amount of active hydrogen groups (mol) in the compound having an isocyanate-reactive group]=100:1 to 100:70. The effective isocyanate groups in the blocked isocyanate compound refer to isocyanate groups that are regenerated when the blocking agent is dissociated from the blocked isocyanate compound.

The curable composition of the present invention can be used as paints for automobiles, for buildings, for metal products such as steel furniture, for wooden products such as musical instruments, for mechanical vehicles such as construction machinery, for building materials such as sashes, and for electrical appliances such as office equipment; coating materials for artificial leather, rubber rolls, etc.; inks, adhesives, pressure-sensitive adhesives, sealing materials for electronic components, sealing materials for automobiles, buildings, etc., molding materials for 3D printers, and the like.

Next, the method for curing the curable composition of the present invention is explained.

The curable composition may be cured with heat (thermosetting composition), or cured with water or moisture (moisture-curable composition). The curable composition may also be cured with heat and water, or heat and moisture. In the case of curing with moisture, an appropriate amount of water can be added to the curable composition.

In the curing method of an embodiment of the present invention, the curable composition containing a blocked isocyanate compound and a metal complex compound, and further optionally a compound having an isocyanate-reactive group, is heated. In the case of curing with heat without curing with water or moisture, the curable composition contains a compound having an isocyanate-reactive group.

The curable composition can be cured with water or moisture, for example, as shown below.

(1) An appropriate amount of water is added to the curable composition, which is cured by the reaction with the water added.
(2) The curable composition is exposed to the air for an appropriate amount of time and cured with moisture in the air.

Further, in the case of curing with water or moisture, heating may be further performed, if necessary.

In curing with heat or curing with heat and water or moisture, the temperature during heating varies depending on the blocked isocyanate compound and the metal complex compound in the curable composition, but is generally about 60 to 250° C., and preferably about 80 to 200° C. The reaction time is about 30 seconds to 5 hours, and preferably about 1 minute to 60 minutes.

The cured product of the present invention can be produced through the above method for curing the curable composition of the present invention.

### EXAMPLES

The present invention is described in more detail below with reference to Production Examples and Examples; however, the present invention is not limited to these Examples.

The abbreviations in the Examples are shown as follows.

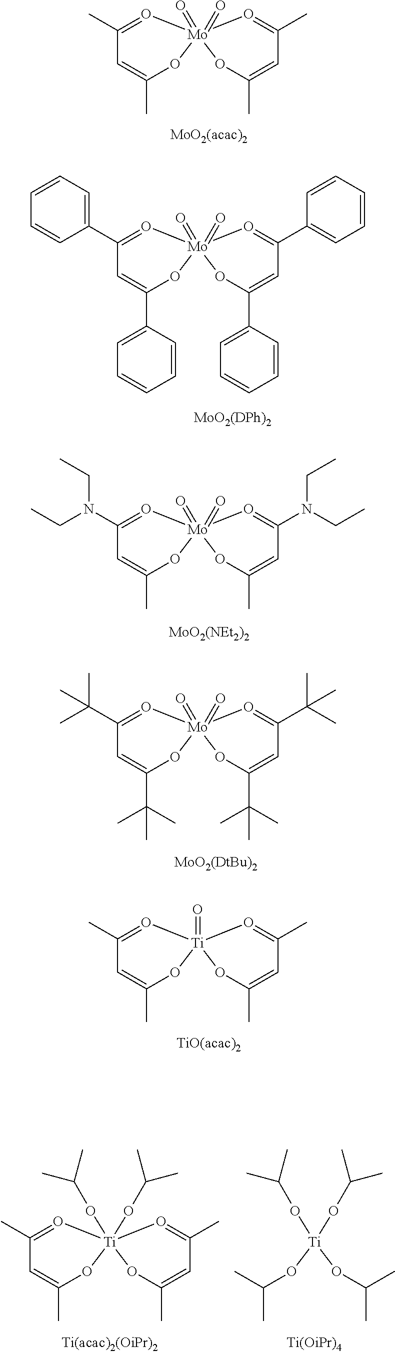

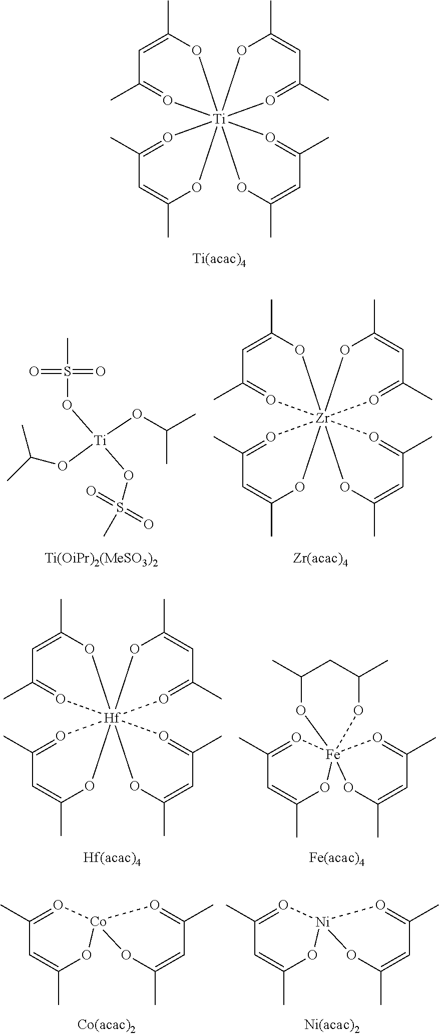

The reagents used in the Examples were those from the following manufacturers.

DABCO: produced by Junsei Chemical Co., Ltd.
MoO₂(acac)₂, DBTDL, bis(2-dimethylaminoethyl)ether, Zr(acac)₄: produced by Tokyo Chemical Industry Co., Ltd.
Fe(acac)₃, Ni(acac)₂, Co(acac)₂: produced by Sigma-Aldrich
Hf(acac)₄: produced by FUJIFILM Wako Pure Chemical Corporation
TiO(acac)₂: produced by Tokyo Chemical Industry Co., Ltd.
Ti(acac)₂(OiPr)₂: produced by Tokyo Chemical Industry Co., Ltd.
Ti(acac)₄: produced by Tokyo Chemical Industry Co., Ltd.

Further, the infrared spectroscopy, curing time, and viscosity were measured under the following conditions.

### Infrared Spectroscopy

Device: FT/IR-6600, produced by JASCO Corporation
Measurement method: total reflection measurement method (crystal: diamond)
Cumulative number: 16

### Curing Time

Device: Madoka automatic curing time measuring device produced by Cyber Co., Ltd.
Stirring rod: Model number 5TC-72890
Stirring rate: rotation 100 rpm, revolutions 25 rpm

### Viscosity

Device: EMS Viscometer, produced by Kyoto Electronics Manufacturing Co., Ltd.
Model number: EMS-1000
Aluminum probe: 4.7 mm in diameter
Measurement time: 30 seconds
Number of revolutions: 1000 rpm
Measurement temperature: 25° C.

### Production Example A-1: Synthesis of MoO₂(DPh)₂

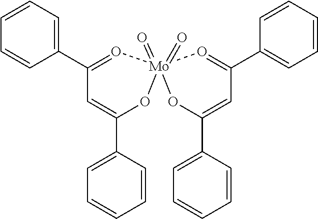

4.8 g of Na₂MoO₄ (23.5 mmol, produced by FUJIFILM Wako Pure Chemical Corporation) and 135 g of H₂O were placed in a 1 L four-necked reactor purged with nitrogen, and dissolved. Thereafter, a solution of 9.98 g of 1,3-diphenyl-1,3-propanedione (produced by Tokyo Chemical Industry Co., Ltd.; “DPhH” below) dissolved in 135 g of a 0.2M HCl/EtOH solution (produced by Junsei Chemical Co., Ltd.) was all added dropwise for 2 hours. After dropwise addition, the mixture was stirred for 1 hour to obtain a yellow suspension. The suspension was filtered to obtain 10 g of a yellow solid of MoO₂(DPh)₂.

### Production Example A-2: Synthesis of MoO₂(NEt)₂

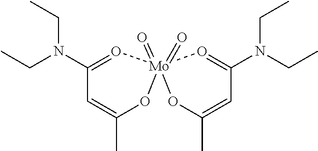

100 mg of MoO₃-2H₂O (0.5 mmol, produced by FUJIFILM Wako Pure Chemical Corporation) and 435 mg of N,N-diethylacetamide (2.7 mmol, produced by Tokyo Chemical Industry Co., Ltd.) were added to a 13 ml test tube and heated under reduced pressure at 70° C. for 5 hours to obtain a yellow homogeneous liquid. The obtained yellow homogeneous liquid was cooled and added to 2.00 g of hexane (produced by Junsei Chemical Co., Ltd.), followed by stirring, and the hexane layer was then extracted. This operation was performed three times to obtain yellow crystals. The obtained yellow crystals were vacuum-dried to obtain 186 mg of MoO₂(NEt)₂.

### Production Example A-3: Synthesis of Ti(OiPr)₂(MeSO₃)₂

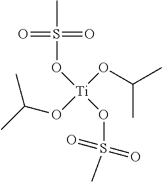

1 g of titanium tetraisopropoxide (3.51 mmol, produced by Tokyo Chemical Industry Co., Ltd.) and 0.67 g of methanesulfonic acid (7.02 mmol, produced by FUJIFILM Wako Pure Chemical Corporation) were placed in a 13 mL test tube, and 3 g of 2-propanol (produced by Junsei Chemical Co., Ltd.) was added and heated at 70° C. for 5 hours. The heated reaction liquid was cooled to 25° C. and then concentrated under reduced pressure at 60° C., thereby obtaining 0.98 g of Ti(OiPr)₂(MeSO₃)₂ represented by the above formula.

### Production Example B-1: Synthesis of 2HPy-Blocked HDI Biuret

360 g (NCO group: 1.93 mol) of HDI biuret (Desmodur N3200A, NCO group content: 22.8(%), produced by Sumika Covestro Urethane Co., Ltd.) and 232.9 g of ethyl acetate (produced by Junsei Chemical Co., Ltd.; “EtOAc” below) were placed in a 1 L four-necked reactor purged with nitrogen, and heated to 50° C., followed by addition of 1.94 g of triethylamine (produced by Junsei Chemical Co., Ltd.; “TEA” below). Thereafter, 189 g (1.99 mol) of 2-hydroxypyridine (produced by Tokyo Chemical Industry Co., Ltd.; “2HPy” below) was added and stirred at 50° C. for 2 hours. Then, the disappearance of the infrared absorption peak of isocyanate group near 2270 cm⁻¹ was confirmed by infrared spectroscopic analysis, and 781.64 g of an EtOAc solution of 2HPy-blocked HDI biuret was obtained. The obtained 2HPy-blocked HDI biuret had a solids content of 70.9% and an effective NCO group content of 10.57%.

### Production Example B-2: Synthesis of 5M2HPy-Blocked HDI Biuret

15 g (NCO group: 80.3 mmol) of HDI biuret (Desmodur N3200A, NCO group content: 22.8(%), produced by Sumika Covestro Urethane Co., Ltd.) and 6.1 g of EtOAc were placed in a 200 mL three-necked reactor purged with nitrogen, and heated to 50° C., followed by addition of 0.21 g of TEA. Thereafter, 9.43 g (86.5 mmol) of 5-methyl-2-hydroxypyridine (produced by Tokyo Chemical Industry Co., Ltd.; “5M2HPy” below) was added and stirred at 60° C. for 2 hours. Then, the disappearance of the infrared absorption peak of isocyanate group near 2270 cm⁻¹ was confirmed by infrared spectroscopic analysis, and 29.0 g of an EtOAc solution of 5M2HPy-blocked HDI biuret was obtained. 4.93 g of EtOAc was added to the obtained solution. The obtained 5M2HPy-blocked HDI biuret had a solids content of 70% and an effective NCO group content of 9.9%.

### Production Example B-3: Synthesis of 5C2HPy-Blocked HDI Biuret

15 g (NCO group: 80.3 mmol) of HDI biuret (Desmodur N3200A, NCO group content: 22.8(%), produced by Sumika Covestro Urethane Co., Ltd.) and 6.5 g of EtOAc were placed in a 200 mL three-necked reactor purged with nitrogen, and heated to 50° C., followed by addition of 0.21 g of TEA. Thereafter, 10.8 g (84.5 mmol) of 5-chloro-2-hydroxypyridine (produced by Tokyo Chemical Industry Co., Ltd.; “5C2HPy” below) was added and stirred at 60° C. for 2 hours. Then, the disappearance of the infrared absorption peak of isocyanate group near 2270 cm⁻¹ was confirmed by infrared spectroscopic analysis, and 31.6 g of an EtOAc solution of 5C2HPy-blocked HDI biuret was obtained. 4.71 g of EtOAc was added to the obtained solution. The obtained 5C2HPy-blocked HDI biuret had a solids content of 70% and an effective NCO group content of 9.3%.

### Production Example B-4: Synthesis of Imz-Blocked HDI Biuret

15 g (NCO group: 80.3 mmol) of HDI biuret (Desmodur N3200A, NCO group content: 22.8(%), produced by Sumika Covestro Urethane Co., Ltd.) and 5.3 g of tetrahydrofuran (produced by Junsei Chemical Co., Ltd.; “THF” below) were placed in a 200 mL three-necked reactor purged with nitrogen, and heated to 50° C., followed by addition of 0.29 g of EtOAc. Thereafter, 5.9 g (84.5 mmol) of imidazole (produced by Tokyo Chemical Industry Co., Ltd.; “Imz” below) was added and stirred at 60° C. for 2 hours. Then, the disappearance of the infrared absorption peak of isocyanate group near 2270 cm⁻¹ was confirmed by infrared spectroscopic analysis, and 25.7 g of a THF solution of Imz-blocked HDI biuret was obtained. 3.6 g of THF was added to the obtained solution. The obtained Imz-blocked HDI biuret had a solids content of 70% and an effective NCO group content of 11.5%.

### Production Example B-5: Synthesis of MEKO-Blocked HDI Biuret

15 g (NCO group: 0.80 mol) of HDI biuret (Desmodur N3200A, NCO group content: 22.8(%)), 5.5 g of EtOAc, and 0.27 g of TEA were placed in a 200 mL three-necked reactor purged with nitrogen, and heated to 60° C. Thereafter, 7.2 g (84 mmol) of 2-butanone oxime (produced by Tokyo Chemical Industry Co., Ltd.; “MEKO” below) was added dropwise to the reactor and stirred at 60° C. for 1 hour and a half. Then, the disappearance of the infrared absorption peak of isocyanate group near 2270 cm⁻¹ was confirmed by infrared spectroscopic analysis. 4.8 g of EtOAc was added to the obtained reaction solution to obtain 31 g of an EtOAc solution of MEKO-blocked HDI biuret. The obtained MEKO-blocked HDI biuret had a solids content of 70% and an effective NCO group content of 10.8%.

### Production Example B-6: Synthesis of DMP-Blocked HDI Biuret

60 g (NCO group: 326 mmol) of HDI biuret (Desmodur N3200A, NCO group content: 22.8(%)) and 60 g of 4-methyl-2-pentanone (produced by Junsei Chemical Co., Ltd.; “MIBK” below) were placed in a 200 mL three-necked reactor purged with nitrogen, and heated to 65° C., followed by addition of 0.64 g of TEA. Thereafter, 31.9 g (333 mmol) of 3,5-dimethylpyrazole (produced by Tokyo Chemical Industry Co., Ltd.; “DMP” below) was added and stirred at 65° C. for 1 hours. Then, the disappearance of the infrared absorption peak of isocyanate group near 2270 cm⁻¹ was confirmed by infrared spectroscopic analysis. The obtained reaction solution was concentrated under reduced pressure to remove TEA and most of MIBK, and 24 g of MIBK was added, thereby obtaining 121 g of a MIBK solution of DMP-blocked HDI biuret. The obtained DMP-blocked HDI biuret had a solids content of 76% and an effective NCO group content of 11.3%.

### Production Example C-1: Synthesis of Acrylic Polyol

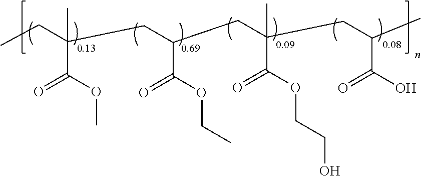

17.5 g of dipropylene glycol methyl ether (produced by Tokyo Chemical Industry Co., Ltd.) and 11.8 g of propylene glycol methyl ether (produced by Sigma-Aldrich) were added to a 200 mL four-necked flask, and nitrogen gas was bubbled for 30 minutes, followed by heating to 105° C. Then, a mixed solution of 9.6 g of methyl methacrylate (96 mmol, produced by Tokyo Chemical Industry Co., Ltd.), 50.0 g of ethyl acrylate (499 mmol, produced by Tokyo Chemical Industry Co., Ltd.), 5.0 g of methacrylic acid (58 mmol, produced by FUJIFILM Wako Pure Chemical Corporation), and 8.5 g of 2-hydroxyethyl methacrylate (65 mmol, produced by Tokyo Chemical Industry Co., Ltd.), and a mixed solution of 17.5 g of dipropylene glycol methyl ether and 0.7 g of tert-butyl peroxy-2-ethylhexanoate (3 mmol, Nippon Oil & Fats Co., Ltd.) were each added dropwise over 3 hours and stirred at 105° C. for 30 minutes. Thereafter, 3.6 g of dipropylene glycol methyl ether and 0.2 g (1 mmol) of tert-butyl peroxy-2-ethylhexanoate were added dropwise over 30 minutes and further stirred for 2 hours. Then, 58.8 g of EtOAc was added, and the mixture was cooled to room temperature, thereby synthesizing an acrylic polyol. The obtained acrylic polyol was evaluated on the assumption that the solids content was 40% (theoretical value), the acid value was 44 mg KOH/g (theoretical value), and the hydroxyl value was 50 mg KOH/g (theoretical value).

### Example 1

The 2HPy-blocked HDI biuret obtained in Production Example B-1, a polyester polyol (P-510, produced by Kuraray Co., Ltd.), and MoO₂(acac)₂ were added such that the formulation of a curable composition satisfied the following: effective NCO group (mol):hydroxyl group (mol):catalyst (mol)=1.00:0.20:0.05. Further, EtOAc was added such that the amount of solvent was 1.0 times by weight relative to the blocked isocyanate compound. The mixture was then stirred for 30 minutes, thus preparing a curable composition. About 0.6 mL of the prepared curable composition was poured onto the hot plate of the automatic curing time measuring device that had been heated to 80° C., and stirring was performed. During this procedure, the curing time at 80° C. was measured, taking the time between the stirring torque immediately after the start of stirring of less than 1% (0.04 mN·m) and the stirring torque exceeding 20% (0.86 mN·m) as the curing time. Table 1 shows the results.

### Examples 2 to 16 and Comparative Examples 1 to 4

Curable compositions were prepared in the same manner as in Example 1, except that the catalysts shown in Tables 1 and 2 were each used in place of MoO₂(acac)₂ in Example 1, and the curing time at 80° C. was measured. Tables 1 and 2 show the results.

TABLE 1

| | | | | | Com- | Com- | Com- | Com- |
|---|---|---|---|---|---|---|---|---|
| | | | | | parative | parative | parative | parative |
| | | | | | Ex- | Ex- | Ex- | Ex- |
| | | Example | Example | Example | ample | ample | ample | ample |
| | | 1 | 2 | 3 | 1 | 2 | 3 | 4 |
| Polyol | | P-510 | P-510 | P-510 | P-510 | P-510 | P-510 | P-510 |
| Blocked | Isocyanate | HDI | HDI | HDI | HDI | HDI | HDI | HDI |
| isocyanate | compound | biuret | biuret | biuret | biuret | biuret | biuret | biuret |
| compound | Blocking | 2HPy | 2HPy | 2HPy | 2HPy | 2HPy | 2HPy | 2HPy |
| | agent | | | | | | | |
| Catalyst | | MoO₂(acac)₂ | MoO₂(DPh)₂ | MoO₂(NEt)₂ | DBTDL | DABCO | Bis(2- | None |
| | | | | | | | dimethyl- | |
| | | | | | | | amino- | |
| | | | | | | | ethyl)ether | |
| Curing time | | 4 | 4.2 | 10.3 | 56.5 | Not cured | Not cured | Not cured |
| | | min | min | min | min | in 1 hour | in 1 hour | in 1 hour |

DBTDL: dibutyltin dilaurate
DABCO: 1,4-diazabicyclo[2.2.2]octane
acac: acetylacetonate
NEt 1-diethylamino-3-methyl-1,3-diketonate
DPh: 1,3-diphenyl-1,3-diketonate

TABLE 2

| | | Ex- | Ex- | Ex- | Ex- | Ex- | Ex- | Ex- |
|---|---|---|---|---|---|---|---|---|
| | | ample | ample | ample | ample | ample | ample | ample |
| | | 4 | 5 | 6 | 7 | 8 | 9 | 10 |
| Polyol | | P-510 | P-510 | P-510 | P-510 | P-510 | P-510 | P-510 |
| Blocked | Isocyanate | HDI | HDI | HDI | HDI | HDI | HDI | HDI |
| isocyanate | compound | biuret | biuret | biuret | biuret | biuret | biuret | biuret |
| compound | Blocking | 2HPy | 2HPy | 2HPy | 2HPy | 2HPy | 2HPy | 2HPy |
| | agent | | | | | | | |

| | | | | | | | |
|---|---|---|---|---|---|---|---|
| Catalyst | Ti(acac)₂(OiPr)₂ | Ti(acac)₄ | TiO(acac)₂ | Zr(acac)₄ | Hf(acac)₄ | Fe(acac)₃ | Co(acac)₂ |
| Curing time | 4 min | 6 min | 5 min | 8 min | 4 min | 20 min | 21 min |

| | | Ex- | Ex- | Ex- | Ex- | Ex- | Ex- |
|---|---|---|---|---|---|---|---|
| | | ample | ample | ample | ample | ample | ample |
| | | 11 | 12 | 13 | 14 | 15 | 16 |
| Polyol | | P-510 | P-510 | P-510 | P-510 | P-510 | P-510 |
| Blocked | Isocyanate | HDI | HDI | HDI | HDI | HDI | HDI |
| isocyanate | compound | biuret | biuret | biuret | biuret | biuret | biuret |
| compound | Blocking | 2HPy | 2HPV | 2HPy | 2HPy | 2HPy | 2HPy |
| | agent | | | | | | |

| | | | | | | |
|---|---|---|---|---|---|---|
| Catalyst | Ni(acac)₂ | Ti(OiPr)₂(MeSO₃)₂ | TC-245 | TC-750 | TC-810 | TC-400 |
| Curing time | 12 min | 19 min | 28 min | 12 min | 18 min | 1 min |

TC-245 titanium octyleneglycolate (produced by Matsumoto Fine Chemical Co., Ltd.)
TC-750 titanium ethylacetoacetate (produced by Matsumoto Fine Chemical Co., Ltd.)
TC-810 titanium dodecylbenzene sulfonate compound (produced by Matsumoto Fine Chemical Co., Ltd.)
TC-400 titanium ethanolaminate (produced by Matsumoto Fine Chemical Co., Ltd.)

### Examples 17 to 19 and Comparative Examples 5 and 6

Curable compositions were prepared in the same manner as in Example 1, except that the blocked isocyanate compound was changed to those shown in Table 3 in Example 1, and the curing time at 80° C. was measured. Table 3 shows the results. Each blocked isocyanate compound was synthesized by the methods described in Production Examples B-2 to 4.

TABLE 3

| | | | | | Com- | Com- |
|---|---|---|---|---|---|---|
| | | Example | Example | Example | parative | parative |
| | | 17 | 18 | 19 | Example 5 | Example 6 |
| Polyol | | P-610 | P-510 | P-510 | P-510 | P-510 |
| Blocked | Isocyanate | HDI biuret | HDI biuret | HDI biuret | HDI biuret | HDI biuret |
| isocyanate | compound | | | | | |
| compound | Blocking | 5M2HPy | 5C2HPy | Imz | MEKO | DMP |
| | agent | | | | | |
| Catalyst | | MoO₂(acac)₂ | MoO₂(acac)₂ | MoO₂(acac)₂ | MoO₂(acac)₂ | MoO₂(acac)₂ |
| Curing time | | 7 min | 3 min | 14 min | Not cured | Not cured |
| | | | | | in 1 hour | in 1 hour |

5M2HPy: 5-methyl-2-hydroxypyridine
5C2HPy: 5-chloro-2-hydroxypyridine
Imz: imidazole
MEKO: methyl ethyl ketoxime
DMP: dimethyl pyrazole

### Examples 20 to 25

The 2HPy-blocked HDI biuret obtained in Production Example B-1, a polyester polyol (P-510, produced by Kuraray Co., Ltd.), and a catalyst were mixed at the mixing ratio shown in Table 4. Further, ethyl acetate was added such that the amount of solvent was 1.0 times by weight relative to the blocked polyisocyanate compound. The mixture was then stirred for 30 minutes, thus preparing a curable composition. Under nitrogen atmosphere, the prepared curable composition and an aluminum probe were placed in an EMS viscometer measurement test tube, and the test tube was capped. The viscosity of the curable composition in the test tube was measured with an EMS viscometer. After the viscosity measurement, the test tube was allowed to stand in a nitrogen box at room temperature. This operation was repeated, and the number of days with a viscosity increase rate of more than 300% was counted.

### Comparative Example 7

The number of days with a viscosity increase rate of more than 300% was counted in the same manner as in Example 20, except that HDI biuret was used in Example 20 in place of the 2HPy-blocked HDI biuret obtained in Production Example B-1.

TABLE 4

| | | | | | | | | Com- |
|---|---|---|---|---|---|---|---|---|
| | | Example | Example | Example | Example | Example | Example | parative |
| | | 20 | 21 | 22 | 23 | 24 | 25 | Example 7 |
| | Polyol | P-510 | None | P-510 | P-510 | P-510 | None | P-510 |
| Blocked | Isocyanate | HDI | HDI | HDI | HDI | HDI | HDI | HDI |
| isocyanate | compound | biuret | biuret | biuret | biuret | biuret | biuret | biuret |
| compound | Blocking agent | 2HPy | 2HPy | 2HPy | 2HPy | 2HPy | 2HPy | None |
| | Mixing ratio = | 1.00: | 1.00: | 1.00: | 1.00: | 1.00: | 1.00: | 1.00: |
| | (effective NCO group | 0.20: | 0: | 0.70: | 0.50: | 0.20: | 0: | 0.20: |
| | (mol):hydroxyl group | 0.05 | 0.05 | 0.05 | 0.05 | 0.05 | 0.05 | 0.05 |
| | (mol):catalyst (mol) | | | | | | | |
| | Catalyst | MoO₂(acac)₂ | MoO₂(acac)₂ | Ti(acac)₂(OiPr)₂ | Ti(acac)₂(OiPr)₂ | Ti(acac)₂(OiPr)₂ | Ti(acac)₂(OiPr)₂ | MoO₂(acac)₂ |
| | Number of days | B | A | B | B | B | A | C |
| | with a viscosity | | | | | | | |
| | increase rate of | | | | | | | |
| | more than 300% | | | | | | | |

Number of days with a viscosity increase rate of more than 300%
A: more than 7 days;
B: within 7 days;
C: cured immediately

### Example 26

The 2HPy-blocked HDI biuret obtained in Production Example B-1, a polyester polyol (P-510, produced by Kuraray Co., Ltd.), and Ti(acac)₂(OiPr)₂ were mixed such that the formulation of a curable composition satisfied the following: effective NCO group (mol):hydroxyl group (mol):catalyst (mol)=1.00:0.20:0.05. Further, EtOAc was added such that the amount of solvent was 1.0 times by weight relative to the blocked isocyanate compound. The mixture was then stirred for 30 minutes, thus preparing a curable composition.

About 0.6 mL of the prepared curable composition was poured onto the hot plate of the automatic curing time measuring device that had been heated to 80° C., and stirring was performed. During this procedure, the curing time at 80° C. was measured, taking the time between the stirring torque immediately after the start of stirring of less than 1% (0.04 mN·m) and the stirring torque exceeding 20% (0.86 mN·m) as the curing time. Table 5 shows the results.

### Example 27

A curable composition was prepared in the same manner as in Example 26, except that the polyol compound in Example 26 was changed to the acrylic polyol obtained in Production Example C-1, and the curing time at 80° C. was measured. Table 5 shows the results.

### Example 28

A curable composition was prepared in the same manner as in Example 26, except that the polyester polyol was not used in Example 26 and MoO₂(acac)₂ was used as the catalyst in place of Ti(acac)₂(OiPr)₂, and the curing time at 80° C. was measured. Table 5 shows the results.

### Example 29

A curable composition was prepared in the same manner as in Example 26, except that the polyester polyol was not used in Example 26, and the curing time at 80° C. was measured. Table 5 shows the results.

TABLE 5

| | | Example 26 | Example 27 | Example 28 | Example 29 |
|---|---|---|---|---|---|
| Polyol | | P-510 | Acrylic polyol | None | None |
| Blocked | Isocyanate | HDI biuret | HDI biuret | HDI biuret | HDI biuret |
| polyisocyanate | compound | | | | |
| compound | Blocking agent | 2HPy | 2HPy | 2HPy | 2HPy |

| | | | | |
|---|---|---|---|---|
| Catalyst | Ti(acac)₂(OiPr)₂ | Ti(acac)₂(OiPr)₂ | MoO₂(acac)₂ | Ti(acac)₂(OiPr)₂ |
| Curing time | 4 min | 11.9 min | 11.8 min | 11.4 min |

1. A curable composition comprising one or more metal complex compounds comprising at least one metal from Groups 4 to 13, and a blocked isocyanate compound in which an isocyanate group of an isocyanate compound is blocked with a nitrogen-containing compound represented by the following Formula (1) or Formula (2), 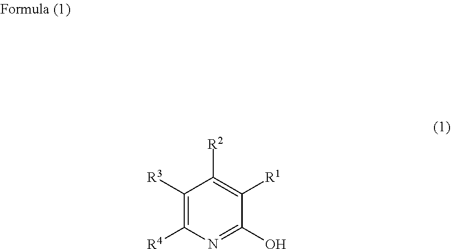
wherein R¹, R², R³, and R⁴ are the same or different, and each represents a C₁₋₂₀ hydrocarbon group optionally containing at least one member selected from the group consisting of a heteroatom and a halogen atom, a hydrogen atom, a halogen atom, or a —X¹R^{a}(R^{b})ₐ₁ group, wherein X¹ is an oxygen atom or a nitrogen atom, a1 is 0 or 1, when X¹ is an oxygen atom, a1 is 0, and when X¹ is a nitrogen atom, a1 is 1; R^{a} and R^{b} are the same or different, and each represents a C₁₋₂₀ hydrocarbon group optionally containing a heteroatom or a halogen atom; R¹ and R² and/or R² and R³ and/or R³ and R⁴ may form a ring structure together with the carbon atoms to which they are bonded; and the heteroatom is at least one member selected from the group consisting of a nitrogen atom, an oxygen atom, and a sulfur atom; or 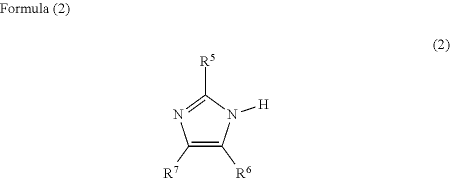
wherein R⁵, R⁶, and R⁷ are the same or different, and each represents a C₁₋₂₀ hydrocarbon group optionally containing at least one member selected from the group consisting of a heteroatom and a halogen atom, a hydrogen atom, a halogen atom, or a —X²R^{c}(R^{d})ₐ₂ group, wherein X² is an oxygen atom or a nitrogen atom, a2 is 0 or 1, when X² is an oxygen atom, a2 is 0, and when X² is a nitrogen atom, a2 is 1; R^{c} and R^{d} are the same or different, and each represents a C₁₋₂₀ hydrocarbon group optionally containing at least one member selected from the group consisting of a heteroatom and a halogen atom; R⁶ and R⁷ may form a ring structure together with the carbon atoms to which they are bonded; and the heteroatom is at least one member selected from the group consisting of a nitrogen atom, an oxygen atom, and a sulfur atom.

2. The curable composition according to claim 1, wherein the metal from Groups 4 to 13 is a metal of Group 4 or 6.

3. The curable composition according to claim 1, wherein the metal from Groups 4 to 13 is titanium of Group 4 or molybdenum of Group 6.

4. The curable composition according to claim 1, wherein the metal complex compound is a metal complex compound having at least one ligand selected from the group consisting of a β-diketonate ligand, an alkoxide ligand, a carboxylate ligand, a sulfonate ligand, and a phosphate ligand.

5. The curable composition according to claim 1, wherein the metal complex compound is a metal complex compound having at least one ligand selected from the group consisting of a β-diketonate ligand represented by the following Formula (3), an alkoxide ligand represented by the following Formula (4), a carboxylate ligand represented by the following Formula (5), a sulfonate ligand represented by the following Formula (6), and a phosphate ligand represented by the following Formula (7), 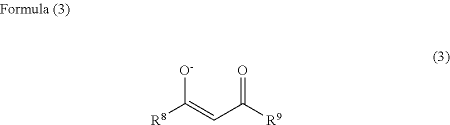
wherein R⁸ and R⁹ are the same or different, and each represents a C₁₋₂₀ hydrocarbon group optionally having at least one member selected from the group consisting of a heteroatom and a halogen atom, or a —X³R^{e}(R^{f})ₐ₃ group, wherein X³ is an oxygen atom or a nitrogen atom, a3 is 0 or 1, when X³ is an oxygen atom, a3 is 0, and when X³ is a nitrogen atom, a3 is 1; R^{e} and R^{f} are the same or different, and each represents a C₁₋₂₀ hydrocarbon group optionally containing at least one member selected from the group consisting of a heteroatom and a halogen atom; and the heteroatom is at least one member selected from the group consisting of a nitrogen atom, an oxygen atom, and a sulfur atom;
Formula (4):
R¹⁰O⁻ (4)
wherein R¹⁰ is a C₁₋₂₀ hydrocarbon group optionally having at least one member selected from the group consisting of a heteroatom, a halogen atom, a hydroxy group, and an oxyanion group (—O⁻ group); and the heteroatom is at least one member selected from the group consisting of a nitrogen atom, an oxygen atom, and a sulfur atom, and is bonded to two carbon atoms;
Formula (5):
R¹¹COO⁻ (5)
wherein R¹¹ is a C₁₋₂₀ hydrocarbon group optionally having at least one member selected from the group consisting of a heteroatom and a halogen atom; and the heteroatom is at least one member selected from the group consisting of a nitrogen atom, an oxygen atom, and a sulfur atom;
Formula (6):
R¹²SO₃⁻ (6)
wherein R¹² is a C₁₋₂₀ hydrocarbon group optionally having at least one member selected from the group consisting of a heteroatom and a halogen atom; and the heteroatom is at least one member selected from the group consisting of a nitrogen atom, an oxygen atom, and a sulfur atom; and 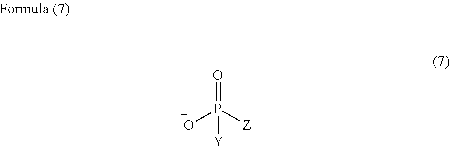
wherein Y is an oxyanion group (—O⁻ group) or OR¹³, Z is an oxyanion group (—O⁻ group) or OR¹⁴; R¹³ and R¹⁴ are the same or different, and each represents a C₁₋₂₀ hydrocarbon group optionally having at least one member selected from the group consisting of a heteroatom and a halogen atom, or a hydrogen atom; and the heteroatom is at least one member selected from the group consisting of a nitrogen atom, an oxygen atom, and a sulfur atom, and is bonded to two carbon atoms.

6. The curable composition according to claim 1, further comprising a compound having an isocyanate-reactive group.

7. The curable composition according to claim 6, wherein the compound having an isocyanate-reactive group is a polyol.

8. The curable composition according to claim 6, wherein the ratio of blocked isocyanate groups in the blocked isocyanate compound and isocyanate-reactive groups in the compound having an isocyanate-reactive group is 100:1 to 100:70.

9. The curable composition according to claim 1, wherein the isocyanate compound is at least one polyisocyanate selected from the group consisting of aliphatic polyisocyanates, alicyclic polyisocyanates, aromatic polyisocyanates, and aromatic aliphatic polyisocyanates, or a modified isocyanate formed from at least one member selected from the group consisting of aliphatic polyisocyanates, alicyclic polyisocyanates, aromatic polyisocyanates, and aromatic aliphatic polyisocyanates.

10. A cured product obtained by heating the curable composition according to claim 1 under air or in the presence of water.

11. A curing catalyst for a blocked isocyanate compound, comprising one or more metal complex compounds comprising at least one metal from Groups 4 to 13, wherein the blocked isocyanate compound is a compound in which an isocyanate group of an isocyanate compound is blocked with a nitrogen-containing compound represented by Formula (1) or Formula (2), 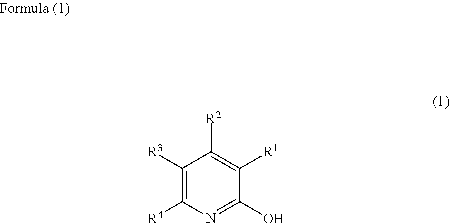
wherein R¹, R², R³, and R⁴ are the same or different, and each represents a C₁₋₂₀ hydrocarbon group optionally containing at least one member selected from the group consisting of a heteroatom and a halogen atom, a hydrogen atom, a halogen atom, or a —X¹R^{a}(R^{b})ₐ₁ group, wherein X¹ is an oxygen atom or a nitrogen atom, a1 is 0 or 1, when X¹ is an oxygen atom, a1 is 0, and when X¹ is a nitrogen atom, a1 is 1; R^{a} and R^{b} are the same or different, and each represents a C₁₋₂₀ hydrocarbon group optionally containing at least one member selected from the group consisting of a heteroatom and a halogen atom; R¹ and R² and/or R² and R³ and/or R³ and R⁴ may form a ring structure together with the carbon atoms to which they are bonded; and the heteroatom is at least one member selected from the group consisting of a nitrogen atom, an oxygen atom, and a sulfur atom; or 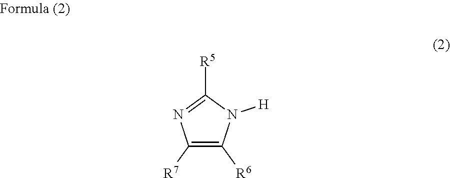
wherein R⁵, R⁶, and R⁷ are the same or different, and each represents a C₁₋₂₀ hydrocarbon group optionally containing at least one member selected from the group consisting of a heteroatom and a halogen atom, a hydrogen atom, a halogen atom, or a —X²R^{c}(R^{d})ₐ₂ group, wherein X² is an oxygen atom or a nitrogen atom, a2 is 0 or 1, when X² is an oxygen atom, a2 is 0, and when X² is a nitrogen atom, a2 is 1; R^{c} and R^{d} are the same or different, and each represents a C₁₋₂₀ hydrocarbon group optionally containing at least one member selected from the group consisting of a heteroatom and a halogen atom; R⁶ and R⁷ may form a ring structure together with the carbon atoms to which they are bonded; and the heteroatom is at least one member selected from the group consisting of a nitrogen atom, an oxygen atom, and a sulfur atom.

12. The curing catalyst for a blocked isocyanate compound according to claim 11, wherein the metal from Groups 4 to 13 is a metal of Group 4 or 6.

13. The curing catalyst for a blocked isocyanate compound according to claim 11, wherein the metal from Groups 4 to 13 is titanium of Group 4 or molybdenum of Group 6.

14. The curing catalyst for a blocked isocyanate compound according to claim 11, wherein the metal complex compound is a metal complex compound having at least one ligand selected from the group consisting of a β-diketonate ligand, an alkoxide ligand, a carboxylate ligand, a sulfonate ligand, and a phosphate ligand.

15. The curing catalyst for a blocked isocyanate compound according to claim 11, wherein the metal complex compound is a metal complex compound having at least one ligand selected from the group consisting of a β-diketonate ligand represented by the following Formula (3), an alkoxide ligand represented by the following Formula (4), a carboxylate ligand represented by the following Formula (5), a sulfonate ligand represented by the following Formula (6), and a phosphate ligand represented by the following Formula (7), 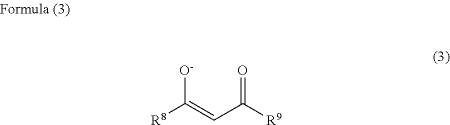
wherein R⁸ and R⁹ are the same or different, and each represents a C₁₋₂₀ hydrocarbon group optionally having at least one member selected from the group consisting of a heteroatom and a halogen atom, or a —X³R^{e}(R^{f})ₐ₃ group, wherein X³ is an oxygen atom or a nitrogen atom, a3 is 0 or 1, when X³ is an oxygen atom, a3 is 0, and when X³ is a nitrogen atom, a3 is 1; R^{e} and R^{f} are the same or different, and each represents a C₁₋₂₀ hydrocarbon group optionally containing at least one member selected from the group consisting of a heteroatom and a halogen atom; and the heteroatom is at least one member selected from the group consisting of a nitrogen atom, an oxygen atom, and a sulfur atom;
Formula (4):
R¹⁰O⁻ (4)
wherein R¹⁰ is a C₁₋₂₀ hydrocarbon group optionally having at least one member selected from the group consisting of a heteroatom, a halogen atom, a hydroxy group, and an oxyanion group (—O⁻ group); and the heteroatom is at least one member selected from the group consisting of a nitrogen atom, an oxygen atom, and a sulfur atom, and is bonded to two carbon atoms;
Formula (5):
R¹¹COO⁻ (5)
wherein R¹¹ is a C₁₋₂₀ hydrocarbon group optionally having at least one member selected from the group consisting of a heteroatom and a halogen atom; and the heteroatom is at least one member selected from the group consisting of a nitrogen atom, an oxygen atom, and a sulfur atom;
Formula (6):
R¹²SO₃⁻ (6)
wherein R¹² is a C₁₋₂₀ hydrocarbon group optionally having at least one member selected from the group consisting of a heteroatom and a halogen atom; and the heteroatom is at least one member selected from the group consisting of a nitrogen atom, an oxygen atom, and a sulfur atom; and 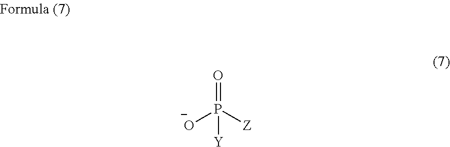
wherein Y is an oxyanion group (—O⁻ group) or OR¹³, Z is an oxyanion group (—O⁻ group) or OR¹⁴; R¹³ and R¹⁴ are the same or different, and each represents a C₁₋₂₀ hydrocarbon group or a hydrogen atom; and the heteroatom is at least one member selected from the group consisting of a nitrogen atom, an oxygen atom, and a sulfur atom, and is bonded to two carbon atoms.

16. The curing catalyst for a blocked isocyanate compound according to claim 11, wherein the metal complex compound is MoO₂(acac)₂, MoO₂(DPh)₂, MoO₂(NEt₂)₂, MoO₂(DtBu)₂, TiO(acac)₂, Ti(acac)₂(OiPr)₂, Ti(OiPr)₄, Ti(acac)₄, (Ti(OiPr)₂(OAc)₂)₂O, Ti(OiPr)₂(MeSO₃)₂, Ti(OiPr)₂(P(OBu)₂O₂)₂, Zr(acac)₄, Hf(acac)₄, Fe(acac)₃, Co(acac)₂, Ni(acac)₂, titanium octyleneglycolate, titanium ethylacetoacetate, a titanium dodecylbenzene sulfonate compound, or titanium ethanolaminate,

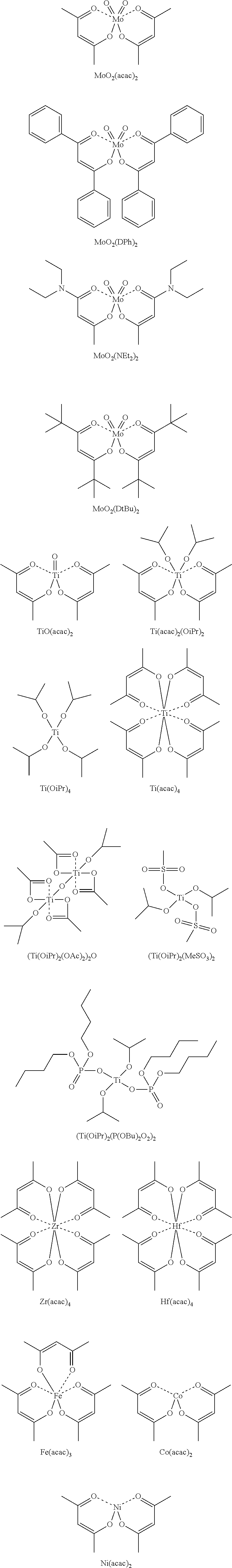

17. Use of one or more metal complex compounds comprising at least one metal from Groups 4 to 13 for producing a curing catalyst for a blocked isocyanate compound, wherein the blocked isocyanate compound is a compound in which an isocyanate group of an isocyanate compound is blocked with a nitrogen-containing compound represented by Formula (1) or Formula (2), 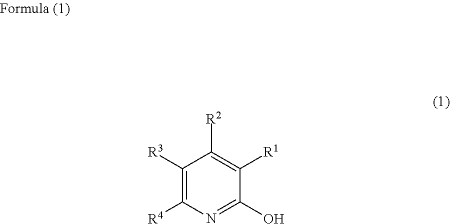
wherein R¹, R², R³, and R⁴ are the same or different, and each represents a C₁₋₂₀ hydrocarbon group optionally containing at least one member selected from the group consisting of a heteroatom and a halogen atom, a hydrogen atom, a halogen atom, or a —X¹R^{a}(R^{b})ₐ₁ group, wherein X¹ is an oxygen atom or a nitrogen atom, a1 is 0 or 1, when X¹ is an oxygen atom, a1 is 0, and when X¹ is a nitrogen atom, a1 is 1; R^{a} and R^{b} are the same or different, and each represents a C₁₋₂₀ hydrocarbon group optionally containing at least one member selected from the group consisting of a heteroatom and a halogen atom; R¹ and R² and/or R² and R³ and/or R³ and R⁴ may form a ring structure together with the carbon atoms to which they are bonded; and the heteroatom is at least one member selected from the group consisting of a nitrogen atom, an oxygen atom, and a sulfur atom; or 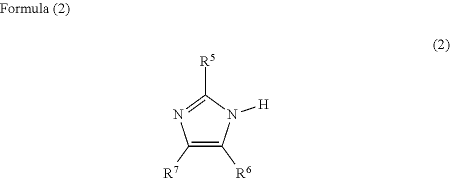
wherein R⁵, R⁶, and R⁷ are the same or different, and each represents a C₁₋₂₀ hydrocarbon group optionally containing at least one member selected from the group consisting of a heteroatom and a halogen atom, a hydrogen atom, a halogen atom, or a —X²R^{c}(R^{d})ₐ₂ group, wherein X² is an oxygen atom or a nitrogen atom, a2 is 0 or 1, when X² is an oxygen atom, a2 is 0, and when X² is a nitrogen atom, a2 is 1; R^{c} and R^{d} are the same or different, and each represents a C₁₋₂₀ hydrocarbon group optionally containing at least one member selected from the group consisting of a heteroatom and a halogen atom; R⁶ and R⁷ may form a ring structure together with the carbon atoms to which they are bonded; and the heteroatom is at least one member selected from the group consisting of a nitrogen atom, an oxygen atom, and a sulfur atom.

18. The use according to claim 17, wherein the metal from Groups 4 to 13 is a metal of Group 4 or 6.

19. The use according to claim 17, wherein the metal from Groups 4 to 13 is titanium of Group 4 or molybdenum of Group 6.

20. The use according to claim 17, wherein the metal complex compound is a metal complex compound having at least one ligand selected from the group consisting of a β-diketonate ligand, an alkoxide ligand, a carboxylate ligand, a sulfonate ligand, and a phosphate ligand.

21. The use according to claim 17, wherein the metal complex compound is a metal complex compound having at least one ligand selected from the group consisting of a β-diketonate ligand represented by the following Formula (3), an alkoxide ligand represented by the following Formula (4), a carboxylate ligand represented by the following Formula (5), a sulfonate ligand represented by the following Formula (6), and a phosphate ligand represented by the following Formula (7), 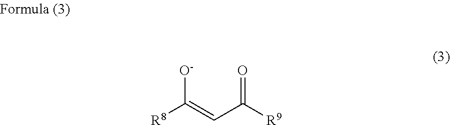
wherein R⁸ and R⁹ are the same or different, and each represents a C₁₋₂₀ hydrocarbon group optionally having at least one member selected from the group consisting of a heteroatom and a halogen atom, or a —X³R^{e}(R^{f})ₐ₃ group, wherein X³ is an oxygen atom or a nitrogen atom, a3 is 0 or 1, when X³ is an oxygen atom, a3 is 0, and when X³ is a nitrogen atom, a3 is 1; R^{e} and R^{f} are the same or different, and each represents a C₁₋₂₀ hydrocarbon group optionally containing at least one member selected from the group consisting of a heteroatom and a halogen atom; and the heteroatom is at least one member selected from the group consisting of a nitrogen atom, an oxygen atom, and a sulfur atom;
Formula (4):
R¹⁰O⁻ (4)
wherein R¹⁰ is a C₁₋₂₀ hydrocarbon group optionally having at least one member selected from the group consisting of a heteroatom, a halogen atom, a hydroxy group, and an oxyanion group (—O⁻ group); and the heteroatom is at least one member selected from the group consisting of a nitrogen atom, an oxygen atom, and a sulfur atom, and is bonded to two carbon atoms;
Formula (5):
R¹¹COO⁻ (5)
wherein R¹¹ is a C₁₋₂₀ hydrocarbon group optionally having at least one member selected from the group consisting of a heteroatom and a halogen atom; and the heteroatom is at least one member selected from the group consisting of a nitrogen atom, an oxygen atom, and a sulfur atom;
Formula (6):
R¹²SO₃⁻ (6)
wherein R¹² is a C₁₋₂₀ hydrocarbon group optionally having at least one member selected from the group consisting of a heteroatom and a halogen atom; and the heteroatom is at least one member selected from the group consisting of a nitrogen atom, an oxygen atom, and a sulfur atom; and 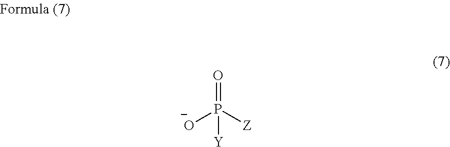
wherein Y is an oxyanion group (—O⁻ group) or OR¹³, Z is an oxyanion group (—O⁻ group) or OR¹⁴; R¹³ and R¹⁴ are the same or different, and each represents a C₁₋₂₀ hydrocarbon group or a hydrogen atom; and the heteroatom is at least one member selected from the group consisting of a nitrogen atom, an oxygen atom, and a sulfur atom, and is bonded to two carbon atoms.

22. The use according to claim 17, wherein the metal complex compound is MoO₂(acac)₂, MoO₂(DPh)₂, MoO₂(NEt₂)₂, MoO₂(DtBu)₂, TiO(acac)₂, Ti(acac)₂(OiPr)₂, Ti(OiPr)₄, Ti(acac)₄, (Ti(OiPr)₂(OAc)₂)O, Ti(OiPr)₂(MeSO₃)₂, Ti(OiPr)₂(P(OBu)₂O₂)₂, Zr(acac)₄, Hf(acac)₄, Fe(acac)₃, Co(acac)₂, Ni(acac)₂, titanium octyleneglycolate, titanium ethylacetoacetate, a titanium dodecylbenzene sulfonate compound, or titanium ethanolaminate,

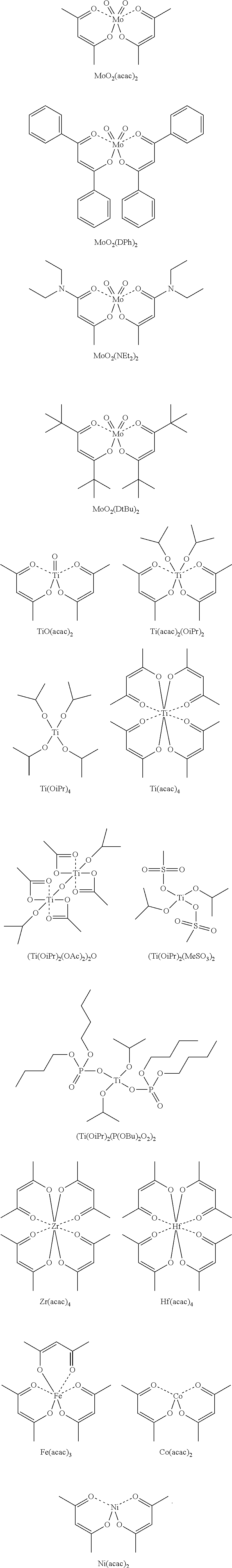

23. A method for curing a blocked isocyanate compound, comprising heating the blocked isocyanate compound in the presence of a curing catalyst for a blocked isocyanate compound comprising one or more metal complex compounds comprising at least one metal from Groups 4 to 13, wherein the blocked isocyanate compound is a compound in which an isocyanate group of an isocyanate compound is blocked with a nitrogen-containing compound represented by Formula (1) or Formula (2), 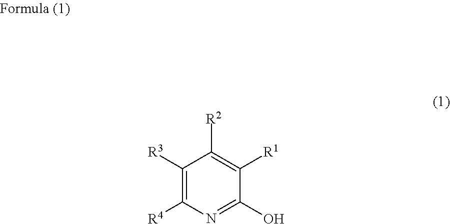
wherein R¹, R², R³, and R⁴ are the same or different, and each represents a C₁₋₂₀ hydrocarbon group optionally containing at least one member selected from the group consisting of a heteroatom and a halogen atom, a hydrogen atom, a halogen atom, or a —X¹R^{a}(R^{b})ₐ₁ group, wherein X¹ is an oxygen atom or a nitrogen atom, a1 is 0 or 1, when X¹ is an oxygen atom, a1 is 0, and when X¹ is a nitrogen atom, a1 is 1; R^{a} and R^{b} are the same or different, and each represents a C₁₋₂₀ hydrocarbon group optionally containing at least one member selected from the group consisting of a heteroatom and a halogen atom; R¹ and R² and/or R² and R³ and/or R³ and R⁴ may form a ring structure together with the carbon atoms to which they are bonded; and the heteroatom is at least one member selected from the group consisting of a nitrogen atom, an oxygen atom, and a sulfur atom; or 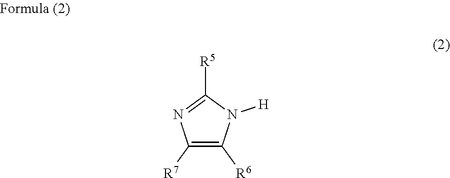
wherein R⁵, R⁶, and R⁷ are the same or different, and each represents a C₁₋₂₀ hydrocarbon group optionally containing at least one member selected from the group consisting of a heteroatom and a halogen atom, a hydrogen atom, a halogen atom, or a —X²R^{c}(R^{d})ₐ₂ group, wherein X² is an oxygen atom or a nitrogen atom, a2 is 0 or 1, when X² is an oxygen atom, a2 is 0, and when X² is a nitrogen atom, a2 is 1; R^{c} and R^{d} are the same or different, and each represents a C₁₋₂₀ hydrocarbon group optionally containing at least one member selected from the group consisting of a heteroatom and a halogen atom; R⁶ and R⁷ may form a ring structure together with the carbon atoms to which they are bonded; and the heteroatom is at least one member selected from the group consisting of a nitrogen atom, an oxygen atom, and a sulfur atom.

24. The method according to claim 23, wherein the metal from Groups 4 to 13 is a metal of Group 4 or 6.

25. The method according to claim 23, wherein the metal from Groups 4 to 13 is titanium of Group 4 or molybdenum of Group 6.

26. The method according to claim 23, wherein the metal complex compound is a metal complex compound having at least one ligand selected from the group consisting of a β-diketonate ligand, an alkoxide ligand, a carboxylate ligand, a sulfonate ligand, and a phosphate ligand.

27. The method according to claim 23, wherein the metal complex compound is a metal complex compound having at least one ligand selected from the group consisting of a β-diketonate ligand represented by the following Formula (3), an alkoxide ligand represented by the following Formula (4), a carboxylate ligand represented by the following Formula (5), a sulfonate ligand represented by the following Formula (6), and a phosphate ligand represented by the following Formula (7), 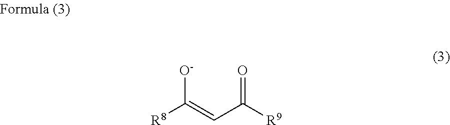
wherein R⁸ and R⁹ are the same or different, and each represents a C₁₋₂₀ hydrocarbon group optionally having at least one member selected from the group consisting of a heteroatom and a halogen atom, or a —X³R^{e}(R^{f})ₐ₃ group, wherein X³ is an oxygen atom or a nitrogen atom, a3 is 0 or 1, when X³ is an oxygen atom, a3 is 0, and when X³ is a nitrogen atom, a3 is 1; R^{e} and R^{f} are the same or different, and each represents a C₁₋₂₀ hydrocarbon group optionally containing at least one member selected from the group consisting of a heteroatom and a halogen atom; and the heteroatom is at least one member selected from the group consisting of a nitrogen atom, an oxygen atom, and a sulfur atom;
Formula (4):
R¹⁰O⁻ (4)
wherein R¹⁰ is a C₁₋₂₀ hydrocarbon group optionally having at least one member selected from the group consisting of a heteroatom, a halogen atom, a hydroxy group, and an oxyanion group (—O⁻ group); and the heteroatom is at least one member selected from the group consisting of a nitrogen atom, an oxygen atom, and a sulfur atom, and is bonded to two carbon atoms;
Formula (5):
R¹¹COO⁻ (5)
wherein R¹¹ is a C₁₋₂₀ hydrocarbon group optionally having at least one member selected from the group consisting of a heteroatom and a halogen atom; and the heteroatom is at least one member selected from the group consisting of a nitrogen atom, an oxygen atom, and a sulfur atom;
Formula (6):
R¹²SO₃⁻ (6)
wherein R¹² is a C₁₋₂₀ hydrocarbon group optionally having at least one member selected from the group consisting of a heteroatom and a halogen atom; and the heteroatom is at least one member selected from the group consisting of a nitrogen atom, an oxygen atom, and a sulfur atom; and 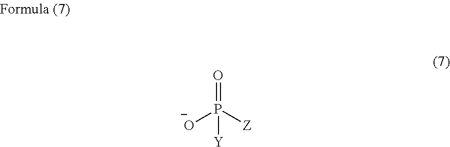
wherein Y is an oxyanion group (—O⁻ group) or OR¹³, Z is an oxyanion group (—O⁻ group) or OR¹⁴; R¹³ and R¹⁴ are the same or different, and each represents a C₁₋₂₀ hydrocarbon group or a hydrogen atom; and the heteroatom is at least one member selected from the group consisting of a nitrogen atom, an oxygen atom, and a sulfur atom, and is bonded to two carbon atoms.

28. The method according to claim 23, wherein the metal complex compound is MoO₂(acac)₂, MoO₂(DPh)₂, MoO₂(NEt₂)₂, MoO₂(DtBu)₂, TiO(acac)₂, Ti(acac)₂(OiPr)₂, Ti(OiPr)₄, Ti(acac)₄, (Ti(OiPr)₂(OAc)₂)O, Ti(OiPr)₂(MeSO₃)₂, Ti(OiPr)₂(P(OBu)₂O₂)₂, Zr(acac)₄, Hf(acac)₄, Fe(acac)₃, Co(acac)₂, Ni(acac)₂, titanium octyleneglycolate, titanium ethylacetoacetate, a titanium dodecylbenzene sulfonate compound, or titanium
ethanolaminate, [chemical structure]
